(19) United States
(12) Patent Application Publication
(10) Pub. No.: US 2026/0213068 A1
(43) Pub. Date: Jul. 23, 2026

(54) COIL COMPONENT, COIL ARRAY SHEET, METHOD FOR PRODUCING COIL COMPONENT, AND ELECTRONIC/ELECTRIC DEVICE

(71) Applicant: DELTA ELECTRONICS (JAPAN), INC., Tokyo (JP)

(72) Inventors: Miyuki SATO, Tokyo (JP); Michio Kamimura, Tokyo (JP); Taishi Numata, Tokyo (JP); Shuji Iguchi, Tokyo (JP); Ikuo Koyama, Tokyo (JP)

(73) Assignee: DELTA ELECTRONICS (JAPAN), INC., Tokyo (JP)

(21) Appl. No.: 19/433,999

(22) Filed: Dec. 29, 2025

Related U.S. Application Data
(63) Continuation of application No. PCT/JP2023/024269, filed on Jun. 29, 2023.

(51) Int. Cl. H01F 41/04; H01F 17/00; H01F 17/04; H01F 27/29

(52) U.S. Cl. CPC H01F 41/046; H01F 27/292; H01F 17/0013; H01F 2017/0073; H01F 17/04; H01F 2017/048

(57) ABSTRACT

Coil component 100A includes coil portion 10 including spiral-shaped first spiral conductor 11 viewed in first direction (Z1-Z2); main body 30 containing magnetic powder, covering while contacting the coil portion by exposing two ends of coil portion 10; discrete conductor 400 partially embedded in main body 30 and spaced from coil portion 10; and paired external electrodes (first and second terminal members 41, 42) exposed from main body 30, contacting ends of coil portion 10, and electrically connected through coil portion 10. When one surface along first direction (Z1-Z2) shared with first spiral conductor 11 is defined as first surface, discrete conductor 400 includes first discrete conductor 401 having first exposed surface 401a exposed from main body 30 in in-plane direction of the first surface. First discrete conductor 401 contacts one of the paired external electrodes (first or second terminal member 41, 42) at first exposed surface 401a.

### CROSS REFERENCE TO RELATED APPLICATION

This application is a continuation application of PCT Application No. PCT/JP2023/024269, filed on Jun. 29, 2023. The content of the application is incorporated herein by reference.

### BACKGROUND OF THE INVENTION

### 1. Field of the Invention

The present invention relates to a coil component, a coil array sheet, and a method for manufacturing a coil component, as well as an electronic/electrical device mounting therein the coil component.

### 2. Description of the Related Art

Patent Document 1 discloses a coil component including a main body, a coil portion disposed inside the main body and including a lead-out pattern, an external electrode disposed on a first surface of the main body, and a plurality of connection vias disposed inside the main body, connecting the external electrode and the lead-out pattern and integrated with each other. In the plurality of connection vias, an area of an end surface of a lower portion that is relatively closer to the external electrode is different from an area of an end surface of an upper portion that is relatively closer to the lead-out pattern. Patent Document 2 discloses a manufacturing method for preventing positional displacement of a coil by means of a guide member, and an electronic component in which a part of the guide member is left inside the main body. Patent Document 3 discloses a manufacturing method for preventing positional displacement of a coil by means of a bridge pattern portion when pressure-bonding magnetic layers, and an electronic component in which the bridge pattern portion is left inside the main body. Patent Document 4 discloses a manufacturing method for preventing positional displacement of a coil by means of holes and column members when thermally compression-bonding a multilayer coil. Patent Document 5 discloses a manufacturing method in which electric current is supplied to each coil by means of lead-in wires.

### PRIOR ART

### Patent Document

[PATENT DOCUMENT 1] US Patent Publication No. 2022/0189680

[PATENT DOCUMENT 2] JP Patent Publication No. 2018-170494

[PATENT DOCUMENT 3] JP Patent Publication No. 2018-101797

[PATENT DOCUMENT 4] JP Patent Publication No. 2000-68143

[PATENT DOCUMENT 5] JP Patent Publication No. 2013-197588

### SUMMARY OF THE INVENTION

### Problems to be Solved by the Invention

In a coil component, the magnetic characteristics of a product greatly change due to a magnetic field generated around, e.g., a connection electrode or a support member. Further, when a coil portion is covered with a main body portion including a magnetic powder, it is desirable to sufficiently secure positioning accuracy of the coil portion with respect to the main body portion and to reduce resistance at a connection interface between the connection electrode and a lead-out portion. An object of the present invention is to provide a coil component, a coil array sheet, a manufacturing method of a coil component, and an electronic/electric device, in which sufficient positioning accuracy of the coil portion with respect to the main body portion, as well as stable magnetic properties, can be obtained.

### Means to Solve the Problems

An aspect of the present invention provided to solve the above problems is a coil component, which includes: a coil portion including a first spiral conductor portion having a spiral shape as viewed in a first direction; a main body portion covering and contacting the coil portion in a manner that two ends of the coil portion are exposed, and including a magnetic powder; a discrete conductor portion having a portion embedded in the main body portion and being spaced from the coil portion; and a pair of external electrodes contacting the two ends of the coil portion, which are exposed from the main body portion, and electrically connected through the coil portion. When a surface shared with the first spiral conductor portion among surfaces extending along the first direction is defined as a first surface, the discrete conductor portion includes a first discrete conductor portion having a first exposed surface exposed from the main body portion in an in-plane direction of the first surface. The first discrete conductor portion contacts one of the pair of external electrodes at the first exposed surface.

In the above coil component, the coil portion may further include a second spiral conductor portion having a spiral shape and arranged alongside the first spiral conductor portion in the first direction, and a via conductor portion contacting one end of the first spiral conductor portion and one end of the second spiral conductor portion to electrically connect the first spiral conductor portion and the second spiral conductor portion in the first direction. When a surface shared with the second spiral conductor portion among the surfaces extending along the first direction is defined as a second surface, the discrete conductor portion has a second exposed surface exposed from the main body portion in an in-plane direction of the second surface and includes a second discrete conductor portion that is electrically independent of the first discrete conductor portion within the main body portion. The second discrete conductor portion may contact the other of the pair of external electrodes at the second exposed surface.

Another aspect of the present invention is a coil component, which includes: a coil portion including a first spiral conductor portion having a spiral shape as viewed in a first direction; a main body portion covering and contacting the coil portion in a manner that two ends of the coil portion are exposed, and including a magnetic powder; and a pair of external electrodes contacting the two ends of the coil portion exposed from the main body portion and electrically connected through the coil portion. The coil portion further includes a first lead-out portion contacting the other end of the first spiral conductor portion and one of the pair of external electrodes. When a surface shared with the first spiral conductor portion among surfaces extending along the first direction is defined as a first surface, the first lead-out portion has a first lead-out exposed surface exposed from the main body portion, and the first lead-out exposed surface extends along a line of intersection between a surface of the main body portion and the first surface.

In the above coil component, the coil portion may further include a second spiral conductor portion having a spiral shape and arranged alongside the first spiral conductor portion in the first direction, a via conductor portion contacting one end of the first spiral conductor portion and one end of the second spiral conductor portion to electrically connect the first spiral conductor portion and the second spiral conductor portion in the first direction, and a second lead-out portion contacting the other end of the second spiral conductor portion and the other of the pair of external electrodes. When a surface shared with the second spiral conductor portion among the surfaces extending along the first direction is defined as a second surface, the second lead-out portion has a second lead-out exposed surface exposed from the main body portion, and the second lead-out exposed surface may extend along a line of intersection between a surface of the main body portion and the second surface.

Another aspect of the present invention is a coil component, which includes: a coil portion including a first spiral conductor portion having a spiral shape as viewed in a first direction; a main body portion covering and contacting the coil portion in a manner that two ends of the coil portion are exposed, and including a magnetic powder; and a pair of external electrodes contacting the two ends of the coil portion exposed from the main body portion and electrically connected through the coil portion. At least one of the two ends of the coil portion extends on a surface of the main body portion along a line where the surface of the main body portion intersects a first surface extending along the first direction and shared with the first spiral conductor portion.

In the above coil component, an envelope shape of the main body portion may be a substantially rectangular parallelepiped, and the first discrete conductor portion may be exposed from the main body portion on an edge of the rectangular parallelepiped.

In the above coil component, the envelope shape of the main body portion may be a substantially rectangular parallelepiped, and the second discrete conductor portion may be exposed from the main body portion on an edge of the rectangular parallelepiped.

In the above coil component, the main body portion may have an envelope shape having a pair of intersecting surfaces aligned in the first direction and outer surfaces located between the pair of intersecting surfaces. A point farthest from the first spiral conductor portion on a line of intersection between the outer surface and the first surface may be included in the first exposed surface.

In the above coil component, the main body portion may have an envelope shape having a pair of intersecting surfaces aligned in the first direction and outer surfaces located between the pair of intersecting surfaces. A point farthest from the second spiral conductor portion on a line of intersection between the outer surface and the second surface may be included in the second exposed surface.

In the above coil component, the envelope shape of the main body portion may be a substantially rectangular parallelepiped.

In the above coil component, the main body portion may have an envelope shape having a pair of intersecting surfaces aligned in the first direction and outer surfaces located between the pair of intersecting surfaces. A point farthest from the first spiral conductor portion on a line of intersection between the outer surface and the first surface may be included in exposed surfaces of the two ends of the coil portion exposed from the main body portion.

In the above coil component, a contact surface between the first discrete conductor portion and the main body portion may have a curvature toward a corner of the rectangular parallelepiped within the first surface.

In the above coil component, a contact surface between the second discrete conductor portion and the main body portion may have a curvature toward a corner of the rectangular parallelepiped within the second surface.

In the above coil component, the two ends of the coil portion may become wider in the first surface as the ends get further away from the first spiral conductor portion.

In the above coil component, the two ends of the coil portion may become wider in the second surface as the ends get further away from the second spiral conductor portion.

In the above coil component, the discrete conductor portion may be formed of Cu or a Cu alloy.

Another aspect of the present invention is a coil array sheet, which includes: a plurality of coil portions, each including a first spiral conductor portion having a spiral shape as viewed in a first direction; and a connecting part that connects the plurality of coil portions to each other. An outer end of a spiral in the first spiral conductor portion faces one side of a second direction that is one in-plane direction having the first direction as a normal line. The plurality of coil portions include a first array in which the plurality of first spiral conductor portions are arranged in a third direction that is another in-plane direction having the first direction as a normal line and intersects the second direction. The connecting part includes a first connecting part including a plurality of first coupling parts, which are respectively connected to the outer ends of the plurality of first spiral conductor portions, and a first bridge portion that connects the plurality of first coupling parts and extends as a whole in the third direction. The first bridge portion has a first bending suppression portion that includes a portion extending in a direction intersecting the third direction and suppresses bending of the first bridge portion in a direction other than the third direction.

In the above coil array sheet, the coil portion may further include a second spiral conductor portion having a spiral shape and arranged alongside the first spiral conductor portion in the first direction, and a via conductor portion contacting one end of the first spiral conductor portion and one end of the second spiral conductor portion to electrically connect the first spiral conductor portion and the second spiral conductor portion in the first direction. An outer end of a spiral in the second spiral conductor portion faces the other side of the second direction, the plurality of coil portions include a second array in which the plurality of second spiral conductor portions are arranged in the third direction and which is arranged alongside the first array in the first direction. The connecting part has a second connecting part including a plurality of second coupling parts respectively connected to the outer ends of the plurality of second spiral conductor portions, and a second bridge portion that connects the plurality of second coupling parts and extends as a whole in the third direction. The second bridge portion may have a second bending suppression portion that includes a portion extending in a direction intersecting the third direction and suppresses bending of the second bridge portion in a direction other than the third direction.

In the above coil array sheet, the first bending suppression portion may have a crank portion including a portion extending in a direction intersecting the third direction.

In the above coil array sheet, the direction intersecting the third direction may include a component of the first direction.

In the above coil array sheet, the direction intersecting the third direction may include a component of the second direction.

In the above coil array sheet, the first bending suppression portion may include a frame-shaped portion having a polygonal envelope shape when viewed in the first direction or the second direction.

In the above coil array sheet, the first array may be a two-dimensional array in which the first spiral conductor portions are also arranged in a fourth direction that is another in-plane direction having the first direction as a normal line and intersects the third direction. The connecting part may include a plurality of the first bridge portions and a first auxiliary bridge portion connecting two of the first bridge portions adjacent to each other in the fourth direction. The first auxiliary bridge portion may have a first auxiliary bending suppression portion that includes a portion extending in a direction intersecting an extending direction thereof and suppresses bending of the first auxiliary bridge portion.

In the above coil array sheet, the first array may be a two-dimensional array in which the first spiral conductor portions are also arranged in a fourth direction that is another in-plane direction having the first direction as a normal line, the second array may be a two-dimensional array in which the second spiral conductor portions are also arranged in the fourth direction. The connecting part may include a plurality of the first bridge portions and a plurality of the second bridge portions, and may include a first auxiliary bridge portion connecting two of the first bridge portions adjacent to each other in the fourth direction and a second auxiliary bridge portion connecting two of the second bridge portions adjacent to each other in the fourth direction. The first auxiliary bridge portion may have a first auxiliary bending suppression portion that includes a portion extending in a direction intersecting an extending direction thereof and suppresses bending of the first auxiliary bridge portion. The second auxiliary bridge portion may have a second auxiliary bending suppression portion that includes a portion extending in a direction intersecting an extending direction thereof and suppresses bending of the second auxiliary bridge portion.

In the above coil array sheet, the first connecting part may form a first closed path enclosing at least one of the first spiral conductor portions when viewed in the first direction, and the first closed path may have at least one of the first bending suppression portion and the first auxiliary bending suppression portion.

In the above coil array sheet, the first connecting part may form a first closed path enclosing at least one of the first spiral conductor portions when viewed in the first direction. The first closed path may have at least one of the first bending suppression portion and the first auxiliary bending suppression portion. The second connecting part may form a second closed path enclosing at least one of the second spiral conductor portions when viewed in the first direction, and the second closed path may have at least one of the second bending suppression portion and the second auxiliary bending suppression portion.

In the above coil array sheet, the first bridge portion and the second bridge portion may have an overlapping portion when viewed in the first direction.

In the above coil array sheet, the first auxiliary bridge portion and the second auxiliary bridge portion may have an overlapping portion when viewed in the first direction.

In the above coil array sheet, the connecting part may have a portion formed from a plated deposit.

Another aspect of the present invention is a method for manufacturing a coil component, which includes: a conductor forming step of forming a conductor on an insulating sheet; a removal step of removing at least a part of an exposed portion of the insulating sheet that is not covered by the conductor to produce a coil array sheet including a plurality of coil portions, each including a spiral conductor portion having a spiral shape as viewed in a first direction and having a portion made of the conductor, and a connecting part connecting the plurality of coil portions; a shape-forming step of covering the coil array sheet with a material containing a magnetic powder and shaping it to form a magnetic sheet having the first direction as a thickness direction; and a cutting step of cutting the magnetic sheet at least in the first direction to form a plurality of coil chips, each including one of the coil portions and the material containing the magnetic powder located around the coil portion. The connecting part has a plurality of closed paths, each of the plurality of closed paths encloses one or more of the spiral conductor portions when viewed in the first direction. The plurality of closed paths have a bending suppression portion that includes a portion extending in a direction intersecting an extending direction of the closed path and suppresses bending of the coil array sheet.

In the above method for manufacturing a coil component, the spiral conductor portion may include a plurality of first spiral conductor portions provided on a first surface, which is one surface of the insulating sheet, and a plurality of second spiral conductor portions provided on a second surface, which is the other surface of the insulating sheet. The connecting part may include a first connecting part provided on the first surface and connecting the plurality of first spiral conductor portions, and a second connecting part provided on the second surface and connecting the plurality of second spiral conductor portions. The insulating sheet has a through hole. The method may further include: in the conductor forming step, forming a via conductor portion inside the through hole as a part of the conductor to electrically connect an inner end part of the first spiral conductor portion and an inner end part of the second spiral conductor portion; an insulating step of forming an insulating layer on a surface of the coil array sheet before the shape-forming step; an outer cover forming step of forming an outer cover made of an insulator on a surface of the magnetic sheet before the cutting step; and an electrode forming step of forming a pair of external electrodes on a surface of the coil chip to electrically connect one of the pair of external electrodes and the other of the pair of external electrodes through the coil portion included in the coil chip. Each of the plurality of closed paths included in the first connecting part may enclose one or more of the spiral conductor portions when viewed in the first direction, and each of the plurality of closed paths included in the second connecting part may enclose one or more of the spiral conductor portions when viewed in the first direction.

In the above method for manufacturing a coil component, the bending suppression portion may have a crank portion including a portion extending in a direction intersecting the extending direction of the closed path.

In the above method for manufacturing a coil component, the insulating sheet may have a connecting part through hole at a position sandwiched between the first connecting part and the second connecting part, and in the conductor forming step, a via connection portion connecting the first connecting part and the second connecting part may be formed inside the connecting part through hole as another part of the conductor.

In the above method for manufacturing a coil component, the bending suppression portion may include a frame-shaped portion having a polygonal envelope shape when viewed in the first direction.

In the above method for manufacturing a coil component, the frame-shaped portion may be provided at a boundary portion between two of the closed paths respectively enclosing two of the spiral conductor portions adjacent to each other in a direction orthogonal to the first direction.

In the above method for manufacturing a coil component, two of the closed paths respectively enclosing two of the spiral conductor portions adjacent to each other in a direction orthogonal to the first direction may have a shared portion, and the bending suppression portion may be provided at the shared portion.

In the above method for manufacturing a coil component, the closed path of the first connecting part and the closed path of the second connecting part may have an overlapping portion that overlaps when viewed in the first direction.

In the above method for manufacturing a coil component, the bending suppression portion may be provided so as to include the overlapping portion and may have a crank portion including a portion extending in a direction intersecting the extending direction of the closed path, and the crank portion may be arranged so as to be sandwiched between two of the overlapping portions when viewed in the first direction.

In the above method for manufacturing a coil component, the closed path may have a rectangular envelope shape when viewed in the first direction.

In the above method for manufacturing a coil component, the coil chip may include a part of the connecting part, and the part of the connecting part may be electrically independent of the coil portion.

Another aspect of the present invention is an electronic/electric device in which the above coil component is mounted, wherein the coil component is connected to a board at terminal portions provided at both ends of the coil portion exposed from the main body portion. Since the electronic/electric device according to the present invention includes the above coil component, Overall properties as an inductance element are excellent.

### [EFFECT OF THE INVENTION]

According to the present invention, there are provided a coil component, a coil array sheet, a manufacturing method of a coil component, and an electronic/electric device, in which sufficient positioning accuracy of a coil portion with respect to a main body portion and stable magnetic properties can be obtained.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a perspective view schematically illustrating a shape of a coil component according to an embodiment of the present invention.

FIG. 2 is a view for illustrating a structure of a coil conductor portion included in the coil component according to an embodiment of the present invention.

FIG. 3 is an XY plan view for illustrating a structure of a first spiral conductor portion included in the coil component according to an embodiment of the present invention.

FIG. 4 is an XY plan view for illustrating a structure of a second spiral conductor portion included in the coil component according to an embodiment of the present invention.

FIG. 5 is an XZ cross-sectional view taken along line A-A′ in FIG. 3.

FIG. 6 is a YZ cross-sectional view taken along line B-B′ in FIG. 3.

FIG. 7A is a schematic view illustrating an example of a manufacturing method of the coil component according to an embodiment of the present invention (conductor forming step, removal step).

FIG. 7B is a schematic view illustrating a manufacturing method of a coil array sheet (removal step).

FIG. 7C is a YZ cross-sectional view taken along line C-C′ in FIG. 7A.

FIG. 8 is a schematic view illustrating an example of a manufacturing method of the coil component according to an embodiment of the present invention (shape forming step).

FIG. 9 is a schematic view illustrating an example of a manufacturing method of the coil component according to an embodiment of the present invention (cutting step).

FIG. 10 is a schematic view illustrating an example of a manufacturing method of the coil component according to an embodiment of the present invention (details of cutting positions).

FIG. 11 is a plan view illustrating a coil array sheet according to another example (No. 1).

FIG. 12 is a plan view illustrating a coil component according to another example (No. 1).

FIG. 13 is a plan view illustrating a coil array sheet according to another example (No. 2).

FIG. 14 is a plan view illustrating a coil component according to another example (No. 2).

FIG. 15 is a plan view illustrating a coil array sheet according to another example (No. 3).

FIG. 16 is a plan view illustrating a coil array sheet according to another example (No. 3).

FIG. 17 is a plan view illustrating a coil component according to another example (No. 3).

FIG. 18 is a plan view illustrating a coil component according to another example (No. 3).

FIG. 19 is a plan view illustrating a coil array sheet according to another example (No. 4).

FIG. 20 is a plan view illustrating a coil array sheet according to another example (No. 4).

FIG. 21 is a plan view illustrating a coil component according to another example (No. 4).

FIG. 22 is a plan view illustrating a coil component according to another example (No. 4).

FIG. 23 is a plan view illustrating a coil array sheet according to another example (No. 5).

FIG. 24 is a plan view illustrating a coil array sheet according to another example (No. 5).

FIG. 25 is a plan view illustrating a coil component according to another example (No. 5).

FIG. 26 is a plan view illustrating a coil component according to another example (No. 5).

FIG. 27 is a plan view illustrating a coil array sheet according to another example (No. 6).

FIG. 28 is a plan view illustrating a coil array sheet according to another example (No. 6).

FIG. 29 is a plan view illustrating a coil component according to another example (No. 6).

FIG. 30 is a plan view illustrating a coil array sheet according to another example (No. 7).

FIG. 31 is a plan view illustrating a coil array sheet according to another example (No. 7).

FIG. 32 is a plan view illustrating a coil component according to another example (No. 7).

FIG. 33 is a plan view illustrating a coil array sheet according to another example (No. 8).

FIG. 34 is a plan view illustrating a coil array sheet according to another example (No. 8).

FIG. 35 is a plan view illustrating a coil component according to another example (No. 8).

FIG. 36 is a plan view illustrating a coil array sheet according to another example (No. 9).

FIG. 37 is a plan view illustrating a coil array sheet according to another example (No. 9).

FIG. 38 is a plan view illustrating a coil component according to another example (No. 9).

FIG. 39 is a plan view illustrating a coil component according to another example (No. 9).

FIG. 40 is a plan view illustrating a coil array sheet according to another example (No. 10).

FIG. 41 is a plan view illustrating a coil array sheet according to another example (No. 10).

FIG. 42 is a plan view illustrating a coil component according to another example (No. 10).

FIG. 43 is a plan view illustrating a coil component according to another example (No. 10).

FIG. 44 is a plan view illustrating a coil array sheet according to another example (No. 11).

FIG. 45 is a plan view illustrating a coil array sheet according to another example (No. 11).

FIG. 46 is a plan view illustrating a coil component according to another example (No. 11).

### DETAILED DESCRIPTION

Below, embodiments according to the present invention will be described in detail with reference to the drawings.

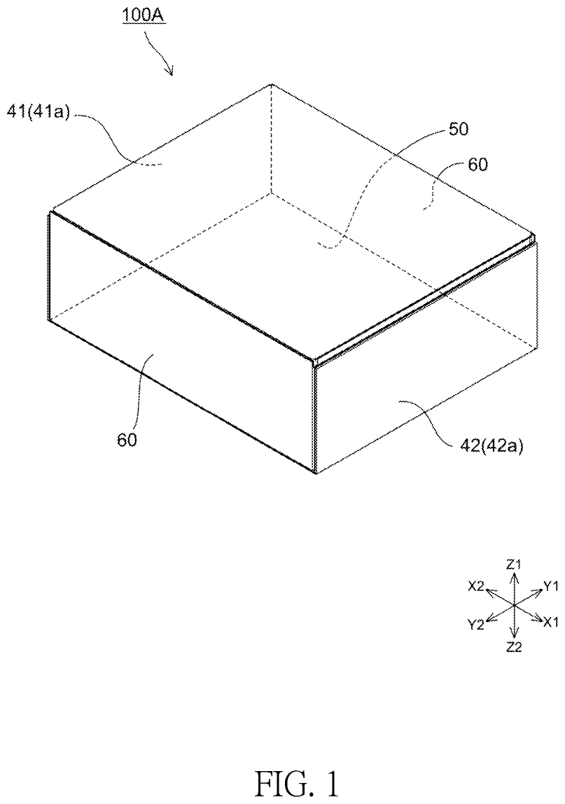

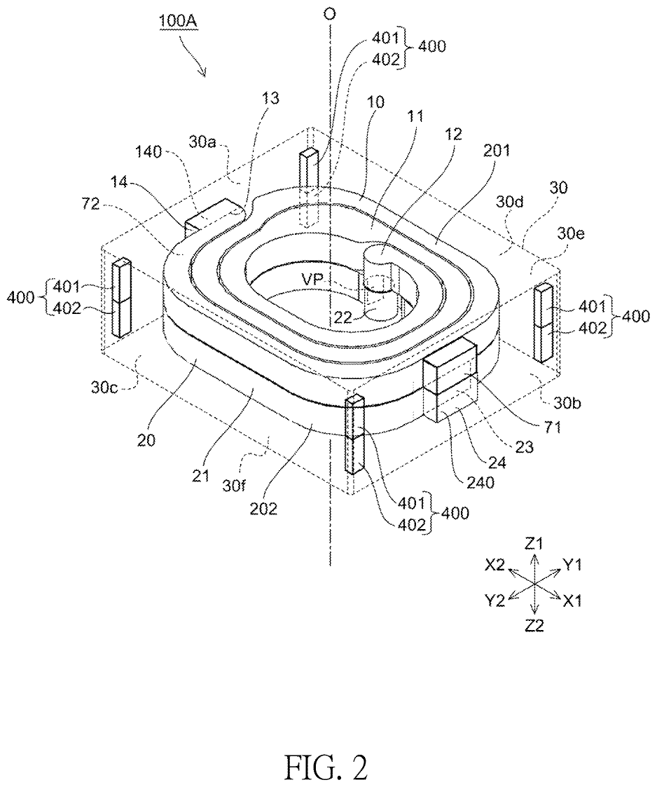

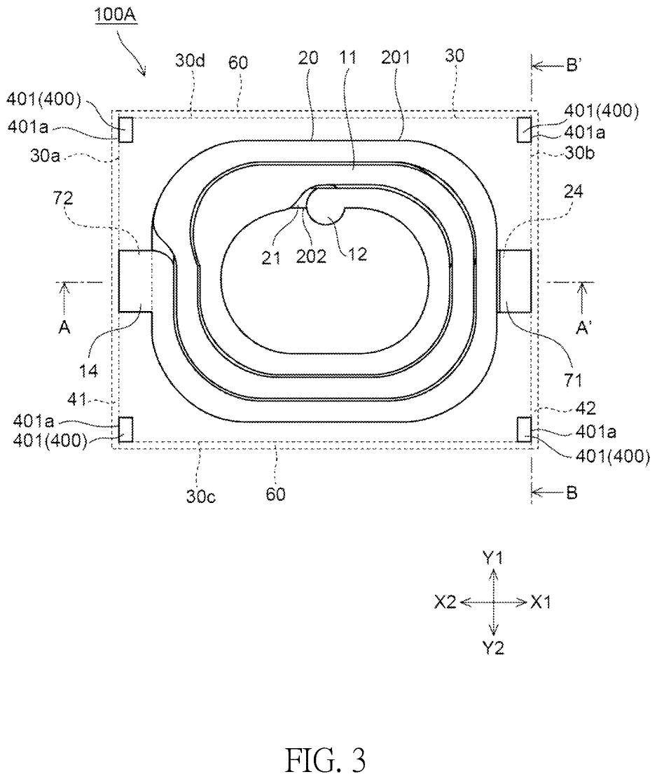

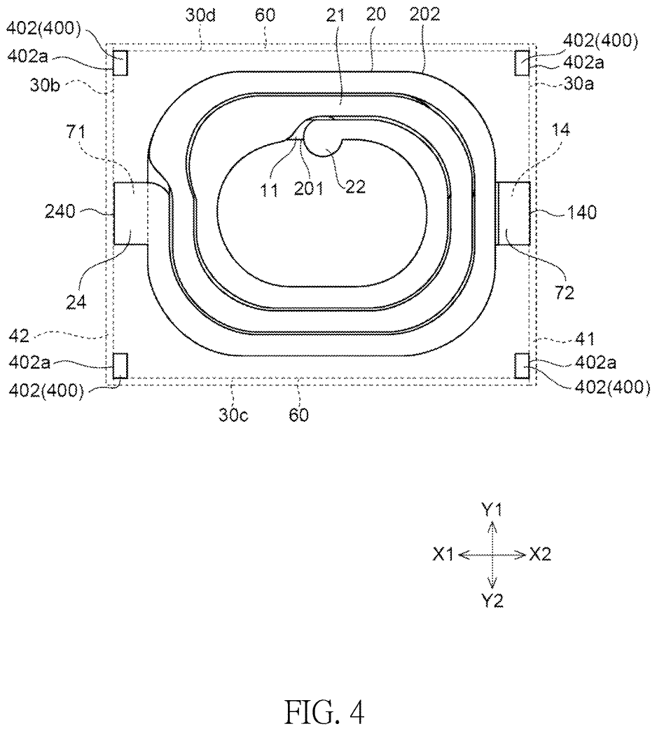

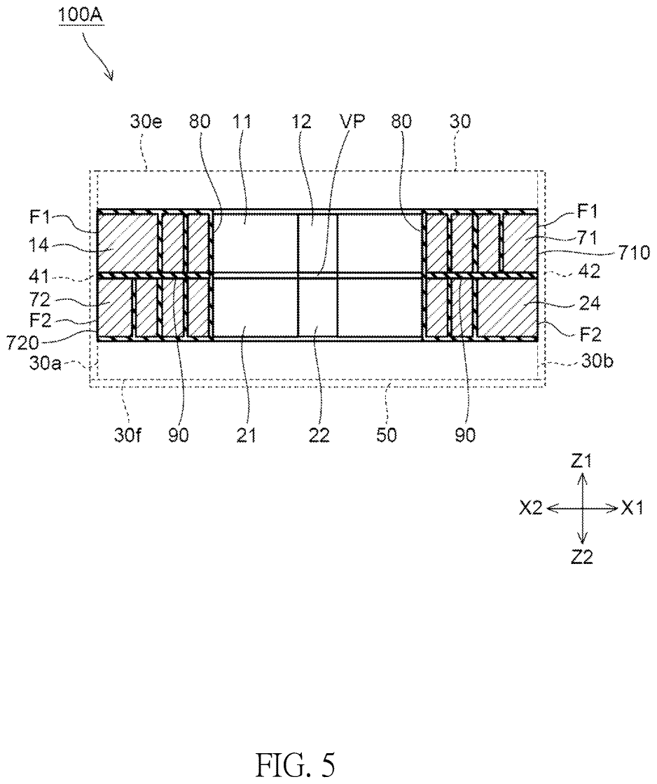

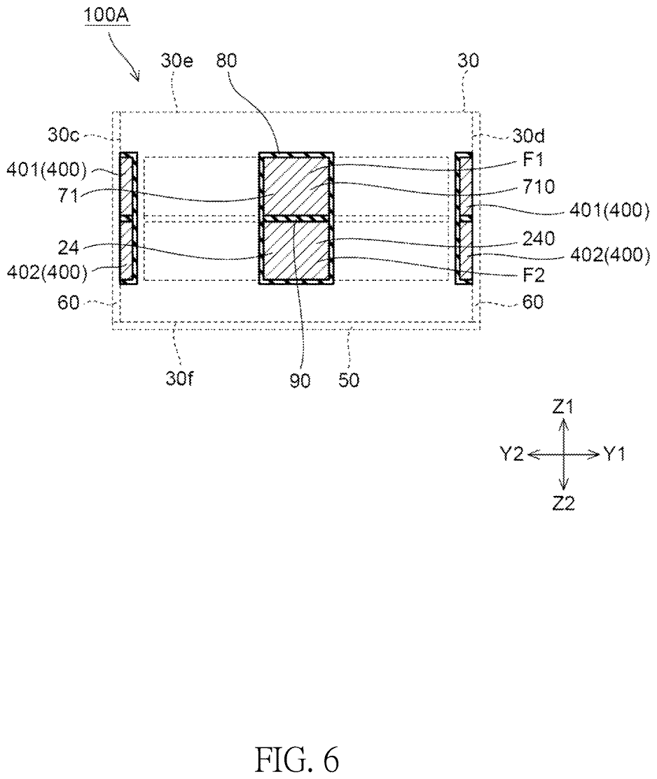

FIG. 1 is a perspective view schematically illustrating a shape of a coil component according to an embodiment of the present invention. FIG. 2 is a view for illustrating a structure of a coil conductor portion included in the coil component according to an embodiment of the present invention, and in FIG. 2, for convenience of explanation, the coil conductor portion and a discrete conductor portion are illustrated by solid lines, the main body portion is illustrated by broken lines, and illustration of other constituent elements is omitted. FIG. 3 is an XY plan view for illustrating a Structure of a first spiral conductor portion included in the coil component according to an embodiment of the present invention. FIG. 4 is an XY plan view for illustrating a structure of a second spiral conductor portion included in the coil component according to an embodiment of the present invention. FIG. 5 and FIG. 6 are cross-sectional views for illustrating a structure of a coil portion included in the coil component according to an embodiment of the present invention. FIG. 2 is a view seen from a Z1 side in a Z1-Z2 direction. FIG. 3 is a plan view seen from the Z1 side in the Z1-Z2 direction, in which the coil conductor portion and the discrete conductor portion are illustrated by solid lines, and other portions are illustrated by broken lines. FIG. 4 is a plan view seen from a Z2 side in the Z1-Z2 direction, in which the coil conductor portion and the discrete conductor portion are illustrated by solid lines, and other portions are illustrated by broken lines. In FIG. 5, the main body portion, a terminal member, and an outer coating are illustrated by broken lines, and a cross section taken along line A-A′ in FIG. 3 is illustrated as an XZ cross-sectional view, and in FIG. 6, the main body portion and the outer coating are illustrated by broken lines, and a cross section taken along line B-B′ in FIG. 3 is illustrated as a YZ cross-sectional view.

### Overall Configuration

A coil component 100A according to an embodiment of the present invention includes a coil portion 10 having a coil conductor portion 20, a main body portion 30, a first terminal member 41, a second terminal member 42, outer coatings 50 and 60, and a discrete conductor portion 400 (first discrete conductor portion 401 and second discrete conductor portion 402).

### Coil

As shown in FIG. 2 and FIG. 3, the coil portion 10 has the coil conductor portion 20 including a first coil conductor portion 201 having a first spiral conductor portion 11 of a spiral shape that extends away from an axis O around the axis O along a first direction (Z1-Z2 direction), from an inner-side end portion 12, which is an inner-side end part amid a pair of end parts of the first spiral conductor portion 11, toward an outer end part 13, which is an outer-side end part amid the pair of end parts of the first spiral conductor portion 11. In FIG. 2, the first spiral conductor portion 11 is arranged such that conductors are disposed in a clockwise spiral shape extending away from the axis O from the inner-side end part 12 toward the outer-side end part 13 as viewed from a Z1 side in the Z1-Z2 direction. In the present specification, a “spiral direction” of a spiral portion means a direction from an inner-side end part toward an outer end part. Further, “as viewed in the first direction” means that the view may be either from the Z1 side in the Z1-Z2 direction or from a Z2 side in the Z1-Z2 direction.

The conductor (conductive material) constituting the coil conductor portion 20 is not particularly limited as long as they have appropriate electrical conductivity. Examples of a metal that may be used as the conductor constituting the coil conductor portion 20 include copper, copper alloys, aluminum, and aluminum alloys, and the coil conductor portion 20 can be manufactured using a film-forming technique such as plating, for example. The coil portion 10 has an insulating coil insulator portion (not illustrated in FIG. 1 to FIG. 4) on a surface of the coil conductor portion 20. With the coil insulator portion, insulation between adjacent conductors (between surfaces of mutually opposing conductors) in the coil conductor portion 20 is ensured. The coil insulator portion is formed of, for example, a resin material. The coil insulator portion is not provided at ends (first lead-out exposed surface 140 and second lead-out exposed surface 240) of two end portions (first lead-out portion 14 and second lead-out portion 24) of the coil conductor portion 20, and the coil portion 10 can be electrically connected to other members at these end portions.

As shown in FIG. 2 and FIG. 4, the coil conductor portion 20 includes a second coil conductor portion 202 having a second spiral conductor portion 21 arranged alongside the first spiral conductor portion 11 in the first direction. The second spiral conductor portion 21 has a spiral shape extending away from the axis O around the axis O along the first direction (Z1-Z2 direction), from one end portion that is an inner-side end part 22 of the second spiral conductor portion 21 toward the other end portion that is an outer -side end part 23 of the second spiral conductor portion 21. In the second spiral conductor portion 21, conductors are arranged in a spiral shape extending away from the axis O in a direction opposite to that of the first spiral conductor portion 11 (counterclockwise in FIG. 2) as viewed from the Z1 side in the Z1-Z2 direction.

An average value of a clearance in the first direction (Z1-Z2 direction) between the first spiral conductor portion 11 and the second spiral conductor portion 21 is not particularly limited. As the clearance decreases, it becomes likely to reduce a height (dimension in Z1-Z2 direction) of the coil component 100A. However, if the clearance is excessively small, insulation between the first spiral conductor portion 11 and the second spiral conductor portion 21 tends to deteriorate. From a viewpoint of achieving both a low profile (low height) of the coil component 100A and high insulation between the first spiral conductor portion 11 and the second spiral conductor portion 21, there may be cases where the clearance is preferably 0.4 μm or more and 20 μm or less. From a manufacturing standpoint, in order to reduce variation in the clearance and to more reliably support the coil within the same plane, the clearance is more preferably 1.0 μm or more, and further preferably 5.0 μm or more.

An inner-side end part 12, which is one end of the first spiral conductor portion 11, and an inner-side end part 22, which is one end of the second spiral conductor portion 21, are electrically connected by a via conductor member VP. With a connecting part to the via conductor member VP as a starting point, the first spiral conductor portion 11 and the second spiral conductor portion 21 spiral in opposite directions to each other. The via conductor member VP may be formed of the same conductor as the coil conductor portion 20. In one specific example, the via conductor member VP is made of the same material as the first spiral conductor portion 11 and the second spiral conductor portion 21, and is manufactured at the same time with the first spiral conductor portion 11 and the second spiral conductor portion 21. In this case, the via conductor member VP is integrated with the inner-side end part 12 of the first spiral conductor portion 11 and the inner-side end part 22 of the second spiral conductor portion 21.

A first lead-out portion 14 is continuously disposed as a part of the first coil conductor portion 201 at an outer end part 13, which is the other end of the first spiral conductor portion 11, and a second lead-out portion 24 is continuously disposed as a part of the second coil conductor portion 202 at an outer end part 23, which is the other end of the second spiral conductor portion 21. Accordingly, the outer end part 13 of the first spiral conductor portion 11 is substantially an interface with the first lead-out portion 14, and the outer end part 23 of the second spiral conductor portion 21 is substantially an interface with the second lead-out portion 24. In one specific example, the first lead-out portion 14 and the second lead-out portion 24 are made of the same material as the first spiral conductor portion 11 and the second spiral conductor portion 21, and are manufactured at the same time with the first spiral conductor portion 11 and the second spiral conductor portion 21. That is, the first coil conductor portion 201 is manufactured integrally, and the second coil conductor portion 202 is also manufactured integrally. In this case, the first lead-out portion 14 is integrated with the outer end part 13 of the first spiral conductor portion 11 without a boundary, and the second lead-out portion 24 is integrated with the outer end part 23 of the second spiral conductor portion 21 without a boundary.

In other words, in the present embodiment, the coil conductor portion 20 includes the first coil conductor portion 201 having the first spiral conductor portion 11 and the first lead-out portion 14, the second coil conductor portion 202 having the second spiral conductor portion 21 and the second lead-out portion 24, and the via conductor portion VP, and these are formed from a common conductive material. As shown in FIG. 3 and FIG. 4, each turn of the first spiral conductor portion 11 and each turn of the second spiral conductor portion 21 are positioned so as to be aligned in the first direction (Z1-Z2 direction).

### Main Body Portion

The main body portion 30 includes magnetic powder, and has outer surfaces 30a, 30b, 30c, and 30d each extending in the first direction, and a pair of intersecting surfaces 30e and 30f aligned in the first direction. The main body portion 30 covers at least a part of the coil portion 10 with the two intersecting surfaces 30e and 30f. In the present embodiment, an envelope shape of the main body portion 30 has a substantially rectangular parallelepiped shape, and has, as the plurality of surfaces, two outer surfaces 30a and 30b arranged in an X1-X2 direction and two outer surfaces 30c and 30d arranged in a Y1-Y2 direction, and has two intersecting surfaces 30e and 30f arranged in the first direction. The outer surfaces 30a, 30b, 30c, and 30d and the intersecting surfaces 30e and 30f, which form the main body portion, are referred to as surfaces of the main body portion. Further, the main body portion 30 encloses portions other than an outermost end surface (on X2 side in X1-X2 direction) of the first lead-out portion 14 located at an end of the coil portion 10 and an outermost end surface (on X1 side in X1-X2 direction) of the second lead-out portion 24. The first lead-out portion 14 has a first lead-out exposed surface 140 that is exposed from the main body portion 30. Among the surfaces extending along the first direction, when a surface shared with the first spiral conductor portion 11 is defined as a first surface F1 (see FIG. 5 and FIG. 6), the first lead-out exposed surface 140 extends along a line of intersection between a surface of the main body portion 30 and the first surface F1. Similarly, the second lead-out portion 24 has a second lead-out exposed surface 240 that is exposed from the main body portion 30. Among the surfaces extending along the first direction, when a surface shared with the second spiral conductor portion 21 is defined as a second surface F2 (see FIG. 5 and FIG. 6), the second lead-out exposed surface 240 extends along a line of intersection between a surface of the main body portion 30 and the second surface F2.

The structure of the magnetic powder is not limited. This Structure may include a crystalline phase or an amorphous phase. Herein, a crystalline material is defined as a material formed of a crystalline phase, an amorphous material is defined as a material formed of an amorphous phase, and a composite material is defined as a material including a crystalline material and an amorphous material. In a situation that the diffraction spectrum obtained by a general X-ray diffraction method includes a sharp diffraction peak that can identify the type of crystalline phase, the material includes a crystalline phase. On the other hand, in the situation that the diffraction spectrum obtained by a general X-ray diffraction method includes a broad peak indicating an amorphous phase, the material includes an amorphous phase. If the DSC curve obtained by differential thermal analysis includes a peak indicating crystallization, i.e., heat generation associated with a phase change from an amorphous phase to a crystalline phase, the material includes an amorphous phase.

The material system of the magnetic powder is not limited. Specific examples of the crystalline material include Fe—Si—Cr based alloys, Fe—Ni based alloys, Fe—Co based alloys, Fe—V based alloys, Fe—Al based alloys, Fe—Si based alloys, Fe—Si—Al based alloys, iron only, and ferrite. It is preferable to use carbonyl iron powder as iron-only powder. Specific examples of the amorphous material include Fe—Si—B based alloys, Fe—P—C based alloys, and Co—Fe—Si—B based alloys. Specific examples of composite materials include Fe—Zr based alloys, Fe—Zr—B based alloys, Fe—Si—B—Nb—Cu based alloys, and Fe—Si—B—P—Cu based alloys. If the magnetic powder is metal powder containing Fe, the synergistic effect on improvement of magnetic properties is particularly significant.

The chemical composition of the magnetic powder is not limited. For example, the Fe—Si—Cr based alloy may be composed of 1.0-10.0 mass % Si, 1.0-10.0 mass % Cr, and the remainder composed of Fe and impurities. Also, for example, the Fe—Ni based alloy may be composed of 1. 0-99. 0 mass % Ni, and the remainder composed of Fe and impurities. Furthermore, for example, the Fe—P—C based alloy may be composed of 1.0-13.0 atom % P, 1.0-13. 0 atom % C, Fe, and impurities. The Fe—P—C based alloy may contain one or more optional elements selected from the group consisting of Ni, Sn, Cr, B, and Si. In this case, for example, the amount of Ni may be 0 to 10.0 atomic %, the amount of Sn may be 0 to 3.0 atom %, the amount of Cr may be 0 to 6.0 atom %, the amount of B may be 0 to 9.0 atom %, and the amount of Si may be 0 to 7. 0 atom %. The amount of Fe is preferably 65 atom % or more. Also, for example, the Fe—Si—B—Nb—Cu based alloy may be composed of 1.0 to 16.0 atom % Si, 1.0 to 15.0 atom % B, 0.50 to 5.0 atom % Nb, 0.50 to 5.0 atom % Cu, and the balance consisting of Fe and impurities. In this case, the amount of Fe is preferably 65 atom % or more.

The shape of the magnetic powder contained in the main body portion 30 is not limited. The magnetic powder may be spherical, elliptical, scaly, or of an irregular shape. The manufacturing method for rendering these shapes is also not limited.

The particle size distribution of the magnetic powder is not limited. The particle size distribution of the magnetic powder can be obtained, for example, by analyzing an image (secondary electron image), which is an image of a cut surface of the main body portion 30 obtained with a scanning electron microscope. For example, the average equivalent circular diameter of the magnetic powder may be 0.50 to 50.0 μm. The distribution of the equivalent circular diameter may include multiple peaks.

The magnetic powder may be subjected to a surface insulating treatment. Provided that the magnetic powder is subjected to a surface insulating treatment, the insulation resistance of the main body portion 30 is improved. There is no limitation on the type of surface insulating treatment applied to the magnetic powder. Examples include phosphoric acid treatment, phosphate treatment, and oxidation treatment. The magnetic powder may have an insulating coating on the surface of the magnetic particles. This insulating coating may contain at least one selected from a group consisting of Si, P, and B, and O (oxygen).

The magnetic powder may be a mixed material in which multiple powder materials are mixed. This magnetic powder is preferably a ferromagnetic material, and more preferably a soft magnetic material.

The main body portion 30 may further include an optional auxiliary material. The optional auxiliary material is, for example, a binder material or a modifier. The binder material bonds particles such as magnetic powder contained in the main body portion 30 together. This binder material is preferably an insulating material to impart insulation resistance to the main body portion 30.

The binding component may be an organic material or an inorganic material. The organic material may be a resin material. Examples of the resin material include acrylic resin, silicone resin, epoxy resin, phenol resin, urea resin, melamine resin, and polyester resin. The inorganic material may be a glass-based material such as water glass. The binding material may be a product of a reaction such as thermal decomposition, or may be a mixture of multiple materials.

The modifier, for example, improves the mobility of the powder or adjusts the curing speed of the binder material. The modifier may be a glass-based material.

The dimension of the main body portion 30 is not limited. For example, the maximum dimension of the main body portion 30 may be 3.2 mm or less.

### External Electrode

As shown in FIG. 2, the outermost (X2 side in X1-X2 direction) end face (first lead-out exposed surface 140) of the first lead-out portion 14 and the outermost (X1 side in X1-X2 direction) end face (second lead-out exposed surface 240) of the second lead-out portion 24, which are located at the ends of coil portion 10, are exposed from the main body portion 30 on the side faces of the main body portion 30 aligned in the X1-X2 direction. A first terminal member 41 is disposed to be in electric contact with the first lead-out exposed surface 140, and a second terminal member 42 is disposed to be in electric contact with the second lead-out exposed surface 240. The first terminal member 41 and the second terminal member 42 are examples of a pair of external electrodes.

The first terminal member 41 has a side portion 41a (with reference to FIG. 1), which covers the side surface of the main body portion 30 on the X2 side in the X1-X2 direction. The second terminal member 42 has a side portion 42a (with reference to FIG. 1), which covers the side surface of the main body portion 30 on the X1 side in the X1-X2 direction. The first terminal member 41 may be designed to have a bottom portion that covers a portion of the bottom surface (surface on Z2 side in Z1-Z2 direction) of the main body portion 30. On the other hand, the second terminal member 42 may be designed to have a bottom portion disposed on the bottom surface of the main body portion 30 so as to cover a portion of the bottom surface, while being spaced from the bottom portion of the first terminal member 41. These bottom portions are the portions facing the board when in use.

The positions of the first terminal member 41 and the second terminal member 42 are not limited to the above positions. The first terminal member 41 and the second terminal member 42 may be formed to cover a portion of the upper surface (surface on Z1 side in Z1-Z2 direction) of the main body portion 30. Alternatively, the first terminal member 41 and the second terminal member 42 may be disposed only on a portion of the bottom surface (surface on Z2 side in Z1-Z2 direction) of the main body portion 30. In this case, the coil conductor portion 20 may have connecting conductor parts (not shown), which connect two ends of the coil portion 10 (first lead-out portion 14, the second lead-out portion 24) to the bottom surface of the main body portion 30 through the inside of the main body portion 30. In this case, the two ends of the coil portion 10 (first lead-out exposed surface 140, the second lead-out exposed surface 240) may not be exposed to the side surfaces of the main body portion 30, and the connecting conductor parts may be exposed to the bottom surface of the main body portion 30.

The material and configuration of the first terminal member 41 and the second terminal member 42 are not limited as long as they have appropriate conductivity. One non-limiting example of the first terminal member 41 and the second terminal member 42 is a layer having a structure of Cu plating/Ni plating/Sn plating from the side proximal to the surface of the main body portion 30. The first terminal member 41 and the second terminal member 42 may be composed of a coated electrode, in which a conductive material such as silver is dispersed in a resin or the like. The first terminal member 41 and the second terminal member 42 may also be a combination of plated layer and coated electrode.

### Outer Cover

On the intersecting surface 30f of the main body portion 30, which is the one located on a Z2 side in the Z1-Z2 direction, and side surfaces aligned in the Y1-Y2 direction, insulating outer covers 50 and 60 are respectively provided as insulating layers. The outer covers 50 and 60 may be provided on a mounting surface of the coil component 100A (surface on a side of the intersecting surface 30e of the main body portion 30, which is the one located on a Z1 side in the Z1-Z2 direction). For example, when a bottom surface portion is provided for each of the first terminal member 41 and the second terminal member 42 so as to extend to a part on a side of the intersecting surface 30e of the main body portion 30, an insulating outer cover may be provided on a portion of the intersecting surface 30e of the main body portion 30, where these bottom surface portions are not provided. The outer covers 50 and 60 may include a layer made of a resin having an average thickness of 0.10 μm to 10.0 μm.

Accordingly, it becomes easier to maintain magnetic properties of the coil component 100A, to enhance insulation of a surface of the coil component 100A and thereby improve reliability of the coil component 100A, and to improve appearance of the coil component 100A. Further, the coil component 100A may not include the outer covers 50 and 60. The outer covers 50 and 60 can be formed at any positions on surfaces of the main body portion 30 according to purposes.

### Dummy Conductor Portion

In the coil component 100A according to the present embodiment, non-spiral first dummy conductor portion 72 and second dummy conductor portion 71 may be provided. As shown in FIG. 5 and FIG. 6, the first dummy conductor portion 72 faces the first lead-out portion 14 in the first direction (Z1-Z2 direction) with a first insulator portion 90 interposed therebetween, and has a portion that is in contact with the first insulator portion 90. Further, the first dummy conductor portion 72 is separated from the second coil conductor portion 202 in a direction intersecting the first direction (specifically, in an X1-X2 direction).

Due to the presence of the first dummy conductor portion 72, a member made of a conductor is positioned in the first direction of the first lead-out portion 14 similarly to the first spiral conductor portion 11. Therefore, when magnetic powder is disposed around the coil portion 10 by applying an external force along the first direction, variation in pressure is less likely to occur, and consequently, deformation of the coil portion 10 is less likely to occur.

In this example, since no conductive material is present between the first dummy conductor portion 72 and the first lead-out portion 14, when viewing the coil portion 10 alone, the first dummy conductor portion 72 and the first lead-out portion 14 are electrically insulated from each other. Therefore, the first dummy conductor portion 72 is in a state of being electrically insulated from both the first coil conductor portion 201 and the second coil conductor portion 202.

In FIG. 5, although an outer end part (on X2 side in X1-X2 direction) of the first dummy conductor portion 72 (dummy exposed surface 720) is exposed, the configuration is not limited thereto. For example, an insulating layer formed of a second insulator portion 80 may be provided so as to be in contact with the dummy exposed surface 720.

A configuration of the second dummy conductor portion 71 is the same as that of the first dummy conductor portion 72. That is, the second dummy conductor portion 71 faces the second lead-out portion 24 in the first direction (Z1-Z2 direction) with the first insulator portion 90 interposed therebetween, has a portion that is in contact with the first insulator portion 90, and is separated from the first coil conductor portion 201 in a direction intersecting the first direction (specifically, X1-X2 direction). By being arranged in this manner, the second dummy conductor portion 71 is also in a State of being electrically insulated from both the first coil conductor portion 201 and the second coil conductor portion 202.

Since the first dummy conductor portion 72 and the first coil conductor portion 201 are electrically connected to each other by the first terminal member 41, they do not necessarily need to be insulated from each other.

Similarly, since the second dummy conductor portion 71 and the second coil conductor portion 202 are electrically connected to each other by the second terminal member 42, they do not necessarily need to be insulated from each other. Therefore, the first dummy conductor portion 72 and the first coil conductor portion 201 may directly contact each other, or may be electrically connected through a conductor portion in a via. Such electrical connection is effective in widening a current path of the coil portion and reducing DCR.

### Discrete Conductor Portion

The discrete conductor portion 400 has a portion embedded in the main body portion 30 and is provided spaced from the coil portion 10. The discrete conductor portion 400 may be formed of the same material as the coil conductor portion 20 in the same manufacturing process. The discrete conductor portion 400 is formed of, for example, Cu or a Cu alloy.

The discrete conductor portion 400 includes a first discrete conductor portion 401 having a first exposed surface 401a that is exposed from the main body portion 30 in an in-plane direction of a first surface F1 (see FIG. 5 and FIG. 6), which is defined as a surface, among the surfaces extending along the first direction (21-Z2 direction), shared with the first spiral conductor portion 11. In the coil component 100A shown in FIG. 2 and FIG. 3, the first discrete conductor portion 401 is provided at each of four corners of the main body portion 30. Each first discrete conductor portion 401 has a first exposed surface 401a that is exposed from each of adjacent outer surfaces forming a corner of the main body portion 30. That is, among intersection lines between the outer surfaces 30a, 30b, 30c, and 30d of the main body portion 30 and the first surface F1, a point farthest from the first spiral conductor portion 11 is included in the first exposed surface 401a. Each of the four first discrete conductor portions 401 contacts, at the first exposed surface 401a, either one of the first terminal member 41 or the second terminal member 42, which are external electrodes. The envelope shape of the main body portion 30 of the coil component 100 according to the present embodiment is substantially shaped as a rectangular parallelepiped, and the first discrete conductor portion 401 is exposed from the main body portion 30 on edges of this rectangular parallelepiped. Specifically, the first discrete conductor portion 401 is exposed from the main body portion 30 at edges defined by an intersection line between the outer surface 30a and the outer surface 30c, an intersection line between the outer surface 30a and the outer surface 30d, an intersection line between the outer surface 30b and the outer surface 30c, an intersection line between the outer surface 30b and the outer surface 30d, an intersection line between the intersecting surface 30e and the outer surface 30a, an intersection line between the intersecting surface 30e and the outer surface 30b, an intersection line between the intersecting surface 30e and the outer surface 30c, and an intersection line between the intersecting surface 30e and the outer surface 30d.

Further, the discrete conductor portion 400 includes a second discrete conductor portion 402 having a second exposed surface 402a that is exposed from the main body portion 30 in an in-plane direction of a second surface F2 (see FIG. 5 and FIG. 6), which is defined as a surface, among the surfaces extending along the first direction (Z1-Z2 direction), shared with the second spiral conductor portion 21. In the coil component 100A shown in FIG. 2 and FIG. 4, the second discrete conductor portion 402 is provided at each of four corners of the main body portion 30. The second discrete conductor portion 402 is electrically independent of the first discrete conductor portion 401 within the main body portion 30. In other words, the first discrete conductor portion 401 and the second discrete conductor portion 402 are electrically insulated from each other. As viewed in the first direction (21-22 direction), the second discrete conductor portion 402 is provided at a position overlapping the first discrete conductor portion 401. Each second discrete conductor portion 402 has a second exposed surface 402a that is exposed from each of adjacent outer surfaces forming a corner of the main body portion 30. That is, among the intersection lines between the outer surfaces 30a, 30b, 30c, and 30d of the main body portion 30 and the second surface F2, a point farthest from the second spiral conductor portion 21 is included in the second exposed surface 402a. Each of the four second discrete conductor portions 402 contacts, at the second exposed surface 402a, either one of the first terminal member 41 or the second terminal member 42, which are external electrodes. The envelope shape of the main body portion 30 of the coil component 100 according to the present embodiment is substantially shaped as a rectangular parallelepiped, and the second discrete conductor portion 402 is exposed from the main body portion 30 on edges of the rectangular parallelepiped. Specifically, the second discrete conductor portion 402 is exposed from the main body portion 30 at edges defined by an intersection line between the outer surface 30a and the outer surface 30c, an intersection line between the outer surface 30a and the outer surface 30d, an intersection line between the outer surface 30b and the outer surface 30c, an intersection line between the outer surface 30b and the outer surface 30d, an intersection line between the intersecting surface 30f and the outer surface 30a, an intersection line between the intersecting surface 30f and the outer surface 30b, an intersection line between the intersecting surface 30f and the outer surface 30c, and an intersection line between the intersecting surface 30f and the outer surface 30d.

As described above, since the first exposed surface 401a of the first discrete conductor portion 401 and the second exposed surface 402a of the second discrete conductor portion 402 are exposed from the main body portion 30, tightness of the first terminal member 41 and the second terminal member 42 provided on the outer surfaces 30a and 30b of the main body portion 30 is improved.

For example, the first terminal member 41 is provided on the outer surface 30a of the main body portion 30, and the second terminal member 42 is provided on the outer surface 30b of the main body portion 30. On the outer surface 30a of the main body portion 30, the first lead-out exposed surface 140 of the first lead-out portion 14 is exposed. Further, on the outer surface 30a of the main body portion 30, an end portion (dummy exposed surface 720) of the first dummy conductor portion 72 may also be exposed. When the first terminal member 41 is connected to the outer surface 30a, tightness between the first terminal member 41 and the first lead-out exposed surface 140 or the dummy exposed surface 720, which are metal materials, is better than tightness to portions where magnetic powder is exposed.

In the present embodiment, the first discrete conductor portion 401 and the second discrete conductor portion 402, which are metal materials, are disposed on the outer surface 30a corresponding to corners of the main body portion 30, and the first exposed surface 401a and the second exposed surface 402a are exposed from the outer surface 30a. Accordingly, good tightness with the first terminal member 41 can also be obtained at these portions. Therefore, tightness of the first terminal member 41 to the main body portion 30 is improved as compared with a case where the first discrete conductor portion 401 and the second discrete conductor portion 402 are not provided.

The issue of tightness of the second terminal member 42 is the same as that of the first terminal member 41. That is, at positions on the outer surface 30b corresponding to corners of the main body portion 30, the first discrete conductor portion 401 and the second discrete conductor portion 402, which are metal materials, are provided. Therefore, on the outer surface 30b, the second lead-out exposed surface 240 of the second lead-out portion 24 is exposed. In addition, on the outer surface 30b, an end portion (a dummy exposed surface 710) of the second dummy conductor portion 71 may also be exposed. Further, on the outer surface 30b, in addition to these, the first exposed surface 401a of the first discrete conductor portion 401 and the second exposed surface 402a of the second discrete conductor portion 402 are exposed. Accordingly, tightness of the second terminal member 42 to the main body portion 30 is improved as compared with a case where the first discrete conductor portion 401 and the second discrete conductor portion 402 are not provided.

Further, in the coil component 100A, since the discrete conductor portion 400 is provided at corners of the main body portion 30 (positions distant from the first spiral conductor portion 11 and the second spiral conductor portion 21), an influence of the discrete conductor portion 400 on coil properties can be suppressed as compared with a case where the discrete conductor portion is provided at another portion.

### Manufacturing Method of Coil Component

A manufacturing method of the coil component according to the present embodiment is not particularly limited. One non-limiting example of the manufacturing method is as follows.

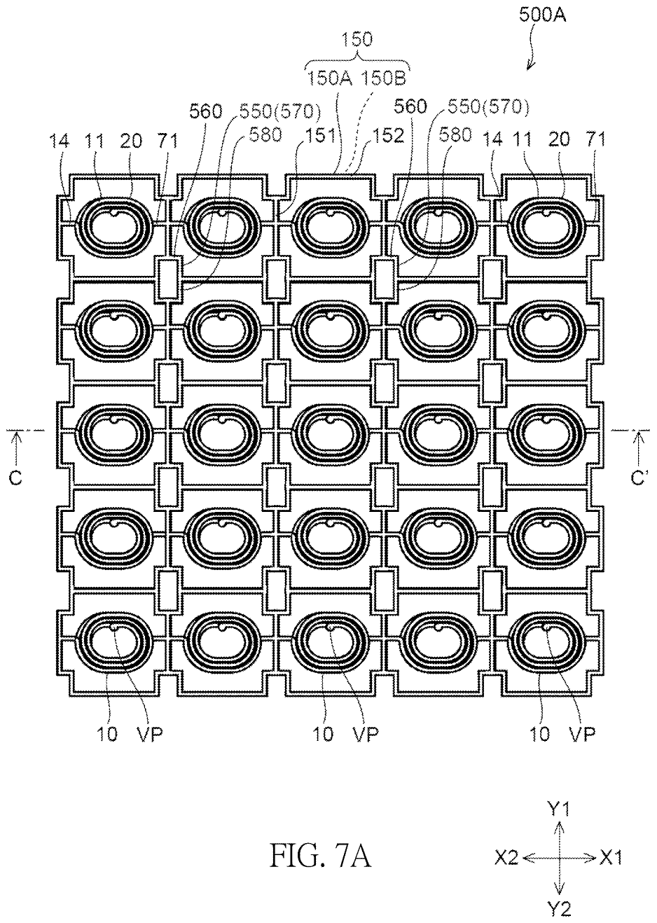

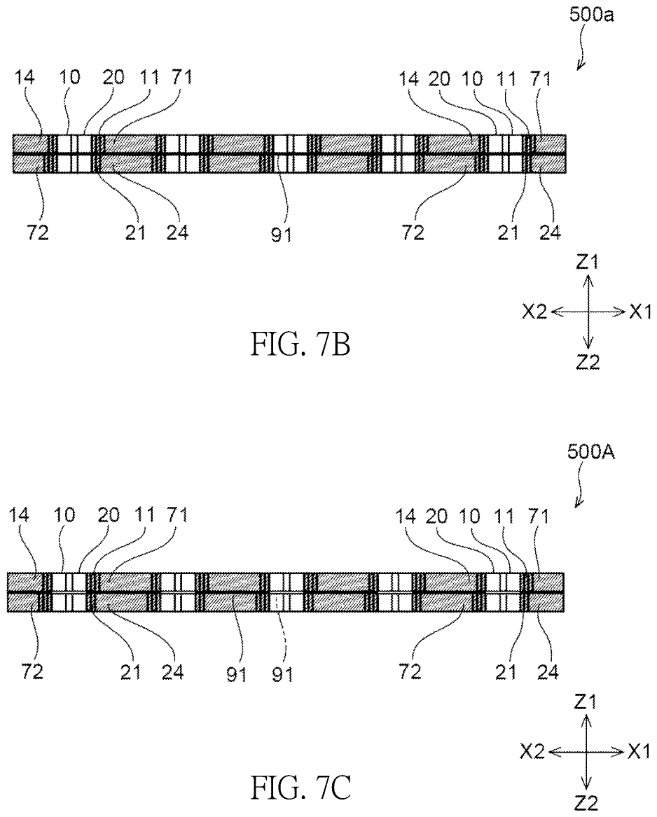

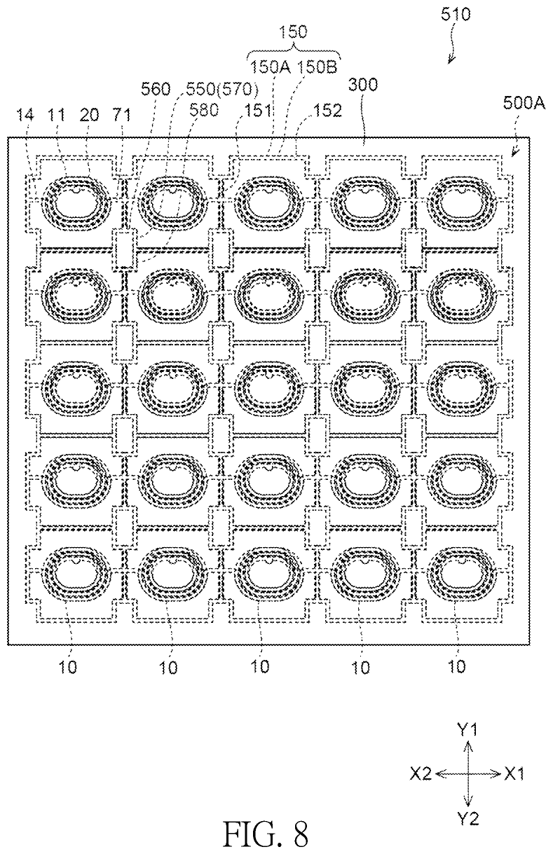

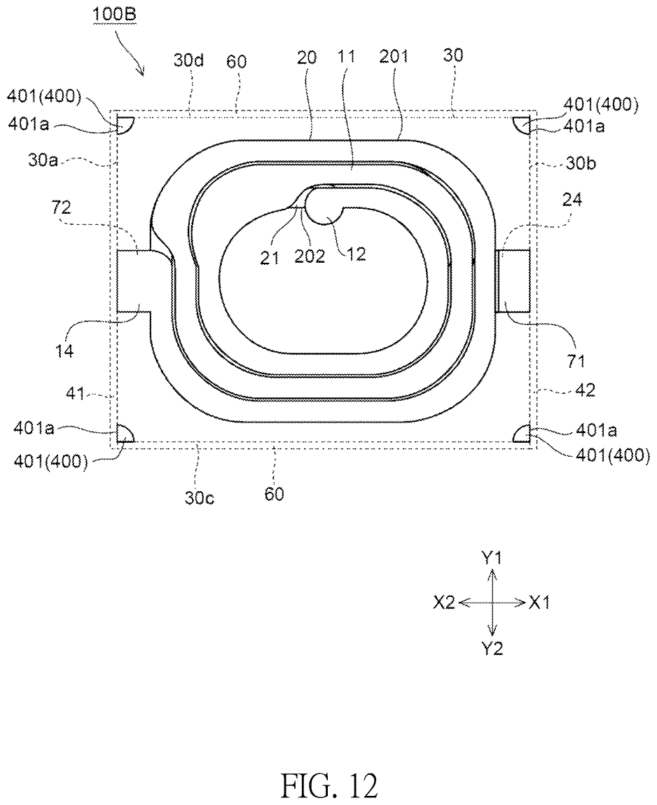

FIG. 7 to FIG. 10 are explanatory views of an example of a manufacturing method of the coil component according to an embodiment of the present invention. FIG. 7 to FIG. 10 illustrate an example of a manufacturing method using the coil component 100A as an example. In explanatory views of a coil array sheet such as FIG. 7A, the shape of a coil differs from that in drawings illustrating a single coil component such as FIG. 12. However, from a viewpoint of describing a manufacturing method of a coil component using a coil array sheet, the shape of the coil does not affect the descriptions.

The manufacturing method of the coil component 100A according to the present embodiment includes a conductor forming step, a removal step, a shape forming step, and a cutting step, which will be described below.

First, as shown in the XY plan view of FIG. 7A, a plurality of spiral portions (first spiral conductor portion 11, second spiral conductor portion 21) are formed. Specifically, conductor layers (seed layers) are first formed on surfaces of a sheet substrate 91 at both sides thereof (Z1 side and Z2 side in Z1-Z2 direction). Next, as shown in FIG. 7B, portions made from conductors are formed on the conductor layers, including respective portions constituting the coil conductor portion 20 (such as first spiral conductor portion 11 and second spiral conductor portion 21, as well as first lead-out portion 14 and second lead-out portion 24, etc.), a first dummy conductor portion 72, a second dummy conductor portion 71, and the like, thereby obtaining a product 500a in the conductor forming step.

The method of forming the conductors is not limited. For example, an insulating layer pattern serving as a negative pattern of a conductor may be formed on the conductor layer on the sheet substrate 91, which is an insulating sheet, and an electroplating process in which electricity is supplied to the conductor layer may be performed, thereby forming plated deposits on the conductor layer exposed around the negative pattern to form the conductor having a desired shape. In this electroplating process, it is also possible to form a via conductor portion VP by filling a through hole of the sheet substrate 91 with a plating material.

Subsequently, in the sheet substrate 91 of the product 500a obtained in the conductor forming step, at least a part of the exposed portion, which is not covered by any conductor in the Z1-Z2 direction, is removed (removal step). Specifically, the sheet substrate 91, including a region surrounded by an inner edge of the first spiral conductor portion 11 when viewed in a first direction (Z1-Z2 direction), is removed. When a negative pattern made of an insulating layer is used in the conductor forming step, the insulating layer is first removed, and then the conductor layer exposed in the Z1-Z2 direction due to removal of the insulating layer is removed. In this manner, a process of removing a portion exposing a part of the sheet substrate 91 in the Z1-22 direction, which is defined to be an exposed portion, is performed.

The specific removal process of the sheet substrate 91 is appropriately set in accordance with the constituent material of the sheet substrate 91. The removal process is briefly classified into a dry process such as plasma etching and a wet process such as wet etching. By the removal process, a part of the sheet substrate 91 may be removed, and there may remain an unremoved portion. For example, when the sheet substrate 91 is a composite material including a matrix portion made of an organic material, and an inorganic material dispersed in the matrix portion, the sheet substrate 91 may be removed by removing the matrix portion made of the organic material in the removal process.

Through the above steps, a coil array sheet 500A is obtained, as shown in the XY plan view of FIG. 7A and shown in the XZ cross-sectional view of FIG. 7C, which is taken along line C-C′ of FIG. 7A. A detailed structure of the coil array sheet 500A will be described later.

Next, as shown in FIG. 8, the coil array sheet 500A is covered with a material containing magnetic powder (magnetic material 300) and shaped to form a magnetic sheet 510 having a first direction (Z1-Z2 direction) as a thickness direction (shape-forming step). As an example of this shape-forming step, a shape-forming process in which the coil array sheet 500A is surrounded by the magnetic material 300 can be exemplified. Specific examples of the shape-forming process include placing the resulting coil array sheet 500A up to the previous steps in a mold and forming it by compression molding the magnetic material 300, or transfer molding the magnetic material 300 or a member serving as raw material thereof. Before this shape-forming step, an insulating step of forming an insulating layer made from a second insulator portion 80 on the surface of the coil array sheet 500A may be performed, whereby insulation between the coil conductor portion 20 and the magnetic powder inside the magnetic material 300 can be enhanced even when the magnetic powder has conductivity.

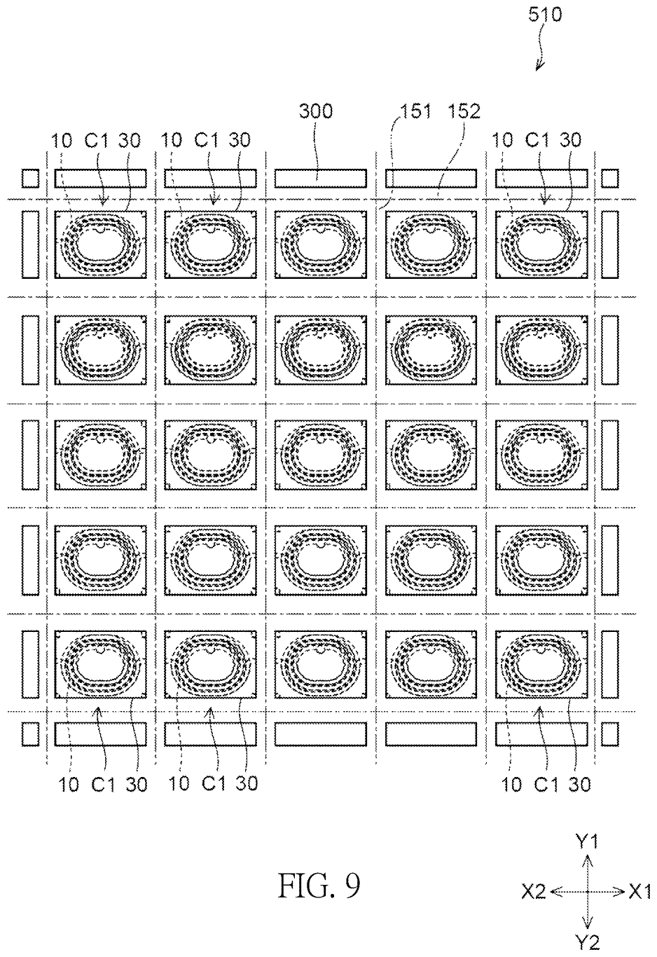

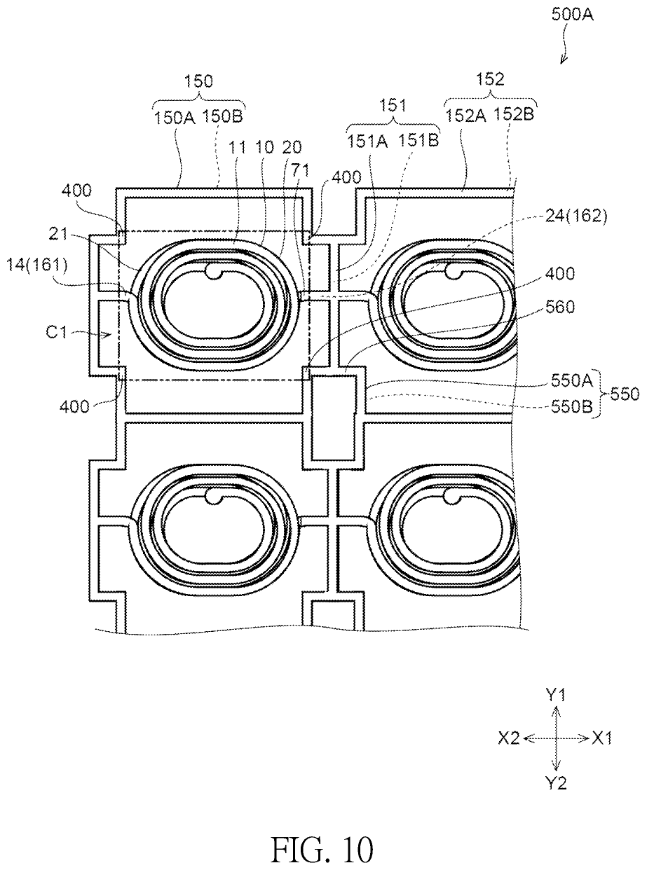

Next, as shown in FIG. 9, the magnetic sheet 510 is cut at least in the first direction (21-22 direction) to form a plurality of coil chips each including one coil portion 10 and the magnetic material 300 located around the coil portion (cutting step). Specifically, as shown in FIG. 9, the magnetic sheet 510 is divided at predetermined positions. In this step, the magnetic sheet 510 is diced along an extending direction of the connecting part 150. In FIG. 9, a one-dot chain line indicates a division line (a center line of division), where the dicing is based. By the dicing, a product C1 having a main body portion 30, in which each coil portion 10 and the magnetic material 300 covering the coil portion are divided, is formed.

In FIG. 10, one region among a plurality of products formed by dicing is indicated by a two-dot chain line. One product C1 formed by dicing includes a portion that remains without being removed by the dicing. This remaining portion becomes the discrete conductor portion 400.

In the dicing in the cutting step, all of the connecting parts 150 may be removed (by pulverization, cutting, or abrasion) so that no connecting part 150 remains in the product C1. In this case, when the magnetic sheet 510 is divided, the connecting parts 150 may partially remain in a residual portion other than the product C1.

Next, an outer cover made of an insulating material (such as outer cover 60) is applied to partial surfaces of the product Cl (outer-cover forming step). The surfaces to which the outer cover is applied are those, among the surfaces of the product C1, on which electrodes are not formed in subsequent steps. In the present embodiment, the outer cover is applied to outer surfaces of the product C1 other than outer surfaces on which a first lead-out exposed surface 140 and a second lead-out exposed surface 240 are exposed. FIG. 12 shows that the outer cover 60 is applied to outer surfaces of the product C1 in the Y1-Y2 direction. The outer cover may be formed before the cutting step or during the cutting step, depending on the surfaces to which the outer cover is applied.

Next, a first terminal member 41 and a second terminal member 42, which are external electrodes, are formed on surfaces of the product C1 including conductive surfaces on which the outer cover is not applied (electrode forming step). The method of forming the first terminal member 41 and the second terminal member 42 is not limited, and examples thereof include a plating process and a printing process using a conductive paste. Thus, a coil component 100A according to the present embodiment is manufactured.

### Coil Array Sheet

Herein, a coil array sheet 500A used in the manufacturing method of the coil component 100A according to the present embodiment will be described. The coil array sheet 500A is a two-dimensional array of coil conductor portions 20, each including a first spiral conductor portion 11 and a second spiral conductor portion 21. In FIG. 7A, a plurality of coil conductor portions 20 are arranged in a third direction (specifically, the Y1-Y2 direction), which is one in-plane direction of a plane having the first direction as a normal direction, and are also arranged in a fourth direction (specifically, the X1-X2 direction), which is another in-plane direction. The coil array sheet 500A includes a plurality of coil conductor portions 20, a first connecting part 150A and a second connecting part 150B (hereinafter collectively referred to as connecting part 150), which connect the plurality of coil conductor portions 20 to each other, and a first dummy conductor portion 72 and a second dummy conductor portion 71. A detailed structure of the coil array sheet 500A will be described below.

First, the coil array sheet 500A includes a plurality of coil portions 10 including the first spiral conductor portions 11 when viewed in the first direction (Z1-Z2 direction), and a first connecting part 150A that connects the plurality of coil portions 10. An outer end of a spiral of the first spiral conductor portion 11 faces one side of a second direction (X1-X2 direction in FIG. 7A), which is an in-plane direction of a plane having the first direction as a normal direction (X2 side in FIG. 7A).

Further, the plurality of coil portions 10 include a first array in which the plurality of first spiral conductor portions 11 are arranged in a third direction (Y1-Y2 direction in FIG. 7A), which is another in-plane direction intersecting the second direction (X1-X2 direction).

The first connecting part 150A includes a plurality of first coupling parts 161 respectively connected to one of the outer ends of the plurality of first spiral conductor portions 11, and first bridge portions 151A that connect the plurality of first coupling parts 161 and extend, as a whole, in the third direction (Y1-Y2 direction in FIG. 7A). The first coupling parts 161 include the first lead-out portion 14. The first connecting part 150A further includes a plurality of first bridge portions 151A and a first auxiliary bridge portion 152A that connects two adjacent first bridge portions 151A.

Then, the first bridge portion 151A includes an intersection portion 560 extending in a direction intersecting the third direction (Y1-Y2 direction in FIG. 7A), and includes a first bending suppression portion 550A that suppresses bending of the first bridge portion 151A.

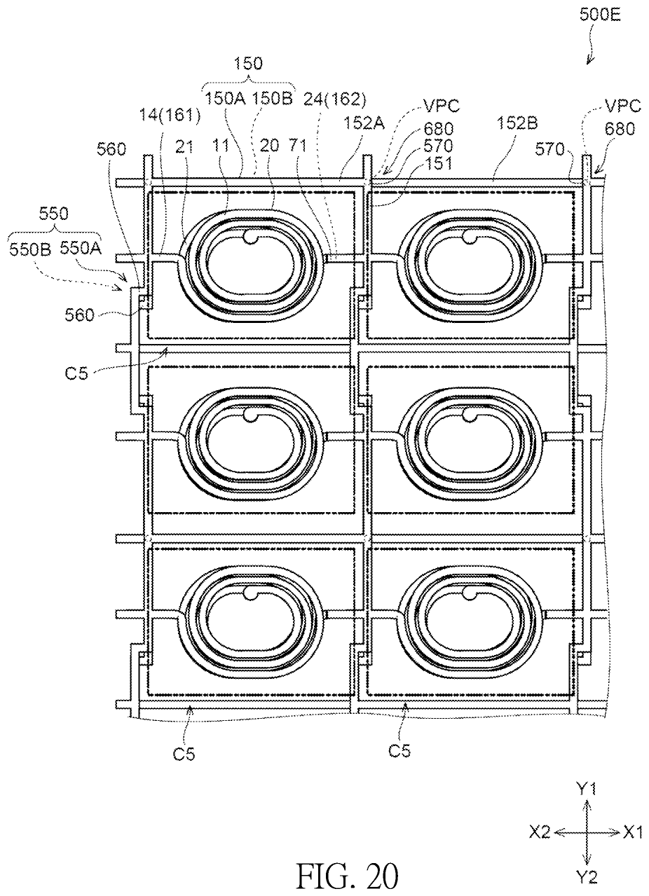

The coil array sheet 500A further includes a plurality of coil portions 10 including the second spiral conductor portions 21 when viewed in the first direction (Z1-Z2 direction), and a second connecting part 150B that connects the plurality of coil portions 10 to each other. The first connecting part 150A and the second connecting part 150B may be connected by a via connection portion VPC made of a conductor (see FIG. 20). The via connection portion VPC can be formed by a method similar to that for forming a via conductor member VP. For example, when the via conductor member VP is formed by a plating process, a connection through hole corresponding to the via connection portion VPC may be provided in the sheet substrate 91, and plated deposits may be filled into the connection through hole in the plating process, thereby forming the via connection portion VPC.

An outer end of a spiral of the second spiral conductor portion 21 faces one side (X1 side in FIG. 7A) of the second direction (X1-X2 direction in FIG. 7A). Furthermore, the plurality of coil portions 10 include a second array in which the plurality of second spiral conductor portions 21 are arranged in the third direction (Y1-Y2 direction in FIG. 7A).

The second connecting part 150B includes a plurality of second coupling parts 162 respectively connected to one of the outer ends of the plurality of second spiral conductor portions 21, and second bridge portions 151B that connect the plurality of second coupling parts 162 and extend, as a whole, in the third direction (for example, Y1-Y2 direction) . The second coupling parts 162 include the second lead-out portion 24. The second connecting part 150B further includes a plurality of second bridge portions 151B and a second auxiliary bridge portion 152B that connects two adjacent second bridge portions 151B.

Then, the second bridge portion 151B includes an intersection portion 560 extending in a direction intersecting the third direction (for example, Y1-Y2 direction), and includes a second bending suppression portion 550B that suppresses bending of the second bridge portion 151B.

The second spiral conductor portion 21 is disposed opposite to the first spiral conductor portion 11 relative to a first insulator portion 90 (see FIG. 5) interposed therebetween. Accordingly, a second coupling part 162, a second bridge portion 151B, a second auxiliary bridge portion 152B, and a second bending suppression portion 550B are also disposed opposite to a first coupling part 161, a first bridge portion 151A, a first auxiliary bridge portion 152A, and a first bending suppression portion 550A relative to the first insulator portion 90 interposed therebetween. Hereinafter, When referring collectively to the first bridge portion 151A and the second bridge portion 151B, they are referred to as a bridge portion 151. Further, when referring collectively to the first auxiliary bridge portion 152A and the second auxiliary bridge portion 152B, they are referred to as a auxiliary bridge portion 152. Further, when referring collectively to the first bending suppression portion 550A and the second bending suppression portion 550B, they are referred to as a bending suppression portion 550. As described above, even in a portion where the first connecting part 150A and the second connecting part 150B are connected in the Z1-Z2 direction by a via connection portion VPC, bending of the coil array sheet 500A may be suppressed. In this case, the first connecting part 150A, the second connecting part 150B, and the via connection portion VPC integrally constitute the bending suppression portion 550. In FIG. 7A, since the first connecting part 150A and the second connecting part 150B of the coil array sheet 500A have overlapping portions when viewed in the first direction, substantially only the first connecting part 150A is shown.

In the coil array sheet 500A configured as described above, the connecting part 150 has a plurality of closed paths. The first connecting part 150A has a first closed path, and the second connecting part 150B has a second closed path. In the coil array sheet 500A, the first closed path and the second closed path have overlapping portions when viewed in the first direction, and therefore, substantially only the first closed path is shown in FIG. 7A. When viewed in the first direction (Z1-Z2 direction), each of the plurality of closed paths includes one or more spiral conductor portions. In the plurality of closed paths, the bending suppression portion 550 includes an intersection portion 560 that extends in a direction intersecting a direction in which the closed path extends. For example, in the coil array sheet 500A shown in FIG. 7A, the first bridge portions 151A forming the plurality of closed paths extend in the Y1-Y2 direction, and the intersection portion 560 extends in a direction intersecting the Y1-Y2 direction, for example, the X1-X2 direction. The intersection portion 560 is bent at both ends from the X1-X2 direction and connected to the first bridge portions 151A extending in the Y1-Y2 direction, thereby forming a crank portion. Thus, the bending suppression portion 550 of the coil array sheet 500A includes a crank portion including the intersection portion 560. The direction intersecting the third direction (Y1-Y2 direction), that is, the direction in which the intersection portion 560 extends, may be the first direction (Z1-Z2 direction) or may be a direction intersecting the first direction. A specific example of such an intersecting direction includes the second direction (X1-X2 direction), which is a direction toward which outer end parts 13 and 23 face.

The rigidity of the connecting part 150 can be increased by the bending suppression portion 550 of the coil array sheet 500A. Due to the increased rigidity of the connecting part 150, deformation (distortion) of the coil array sheet 500A is suppressed during the step of manufacturing the coil array sheet 500A and the step of manufacturing the coil component 100 from the coil array sheet 500A, making it difficult for the plurality of coil conductor portions 20 of the coil array sheet 500A to deviate from predetermined positions. As a result, variation in magnetic and electrical properties of the coil component 100 is less likely to occur, and an improvement in the quality of the coil component 100 is realized.

For example, the coil array sheet 500A may be formed by a method including performing a plating process on a sheet-shaped substrate provided with an insulating negative pattern for the coil conductor portion 20 and the like. In this case, through the plating process, a structure (corresponding to the product 500a of the conductor forming step (see FIG. 7B)) having a sheet-shaped substrate (e.g., the aforementioned sheet substrate 91), and a plurality of coil conductor portions 20 and connecting parts 150 made of plated deposits formed on both surfaces thereof, is formed. This structure formed before the plating process (hereinafter referred to as “structure x”) consists of a portion where plated deposits are to be formed in the plating process and which is substantially made of the substrate (hereinafter referred to as “substrate portion”), and a portion where a negative pattern is provided on at least one surface of the substrate (hereinafter referred to as “negative pattern portion”). In the case where the plating process is performed by electroplating, the substrate portion is in a state where a conductor layer is provided on the substrate. When the substrate of the structure a has a certain degree of rigidity (including the rigidity of the conductor layer when the conductor layer is provided), even if the structure a is lifted, for example, for transportation, deformation of the entire structure & is suppressed by the rigidity of the substrate.

However, if the rigidity of the substrate is reduced, for example, due to thinning of the substrate in response to a demand for miniaturization of the coil component 100, it becomes difficult to suppress the deformation of the structure a by the substrate. Specifically, when an external force (including its own weight) that deforms the structure a is applied, the substrate portion bends easily because its rigidity is particularly lower than that of the negative pattern portion, thereby causing deformation of the structure a as a whole. Due to the bending of the substrate caused by this external force, the distance between adjacent negative pattern portions sandwiching the substrate portion may become narrower. If the plating process is performed on the structure a in this state, unexpectedly narrow portions will occur in the width of the formed plated deposits. Since the cross-sectional area of the conductor made of the plated deposits becomes relatively small in such portions, it causes a local increase in resistance, which can lead to a deterioration in the magnetic and electrical properties of the coil component 100 formed from the coil array sheet 500A.

In the coil array sheet 500A according to the present embodiment, in the state of the structure a, a portion corresponding to the bending suppression portion 550 (substrate bending suppression portion) is provided in the above-mentioned substrate portion. Therefore, the bending of the substrate portion is suppressed compared to a case without the substrate bending suppression portion. Specifically, in the structure a, the extending direction of the substrate portion is not uniform, and the substrate bending suppression portion has a portion (intersection portion) extending in a direction different from another portion (common portion). When there is no substrate bending suppression portion, if an external force in a direction orthogonal in the in-plane direction of the substrate to the extending direction of the common portion of the substrate portion is applied to the structure a, the common portion bends so as to narrow the distance between the negative pattern portions adjacent across the common portion. In contrast, when the structure a has the substrate bending suppression portion, even if an external force in a direction to bend the common portion is applied to the structure a, the external force does not act as a force to bend the substrate at the substrate bending suppression portion, but acts as a force to stretch the substrate. Therefore, even when subjected to the external force, the negative pattern portions adjacent across the substrate bending suppression portion are unlikely to be relatively displaced. As a result, the distance between the negative pattern portions adjacent across the common portion is also maintained. Therefore, the coil component 100A formed from the coil array sheet 500A according to the present embodiment is less prone to quality degradation caused by the narrowing of the width of the plated deposits.

Moreover, when a shape-forming process of surrounding the periphery of the coil array sheet 500A with the magnetic material 300 is performed as a step of manufacturing the coil component 100A, stress during material filling is applied to the coil array sheet 500A. For example, in the case of performing compression molding, the magnetic material 300 is allowed to flow while a compressive force is applied between the mold and the coil array sheet 500A to spread the material into the cavity of the mold, so stress during material filling is applied to the coil array sheet 500A. In particular, when the material in the cavity flows and spreads inside the cavity, the material moves from the cavity toward the coil array sheet 500A, so that stress is intensely applied toward the coil array sheet 500A. In the present embodiment, since the bending suppression portion 550 is provided in the coil array sheet 500A, the deformation of the coil array sheet 500A is suppressed even if the coil array sheet 500A is pressed by the material. That is, positional displacement of each coil portion 10 in the coil array sheet 500A is effectively suppressed.

In the coil array sheet 500A shown in FIG. 7A, the bending suppression portion 550 is provided at each intersection position between the plurality of bridge portions 151 extending in the Y1-Y2 direction and the plurality of auxiliary bridge portions 152 extending in the X1-X2 direction. The bending suppression portion 550 may include a frame-shaped portion having a polygonal envelope shape when viewed in the first direction. In FIG. 7A, this frame-shaped portion has a quadrangular (rectangular) envelope shape when viewed in the first direction. Since the bending suppression portion 550 has the frame-shaped portion, this bending suppression portion 550 can efficiently have the intersection portion 560. In FIG. 7A, for the bridge portion 151 extending in the Y1-Y2 direction, the frame-shaped portion becomes the intersection portion 560 extending in the X1-X2 direction. For the auxiliary bridge portion 152 extending in the X1-X2 direction, the frame-shaped portion is an intersection portion 580 extending in the Y1-Y2 direction in an auxiliary bending suppression portion 570. As shown in FIG. 7A, the above frame-shaped portion may be provided at a boundary portion between two closed paths respectively enclosing two spiral conductor portions (first spiral conductor portion 11, second spiral conductor portion 21) adjacent to each other in directions (X1-X2 direction, Y1-Y2 direction) orthogonal to the first direction. In this case, positional stability of a plurality of closed paths can be improved by a single frame-shaped portion, which is efficient. In FIG. 7A, it is arranged such that one frame-shaped portion is located at a boundary portion of four spiral conductor portions consisting of two spiral conductor portions adjacent in the X1-X2 direction and two spiral conductor portions adjacent in the Y1-Y2 direction.

By providing the bending suppression portion 550 including the intersection portion 560, stress is dispersed at the intersection portion 560 compared to a case where a simple lattice pattern is configured by the bridge portions 151 and the auxiliary bridge portions 152, and bending of the coil array sheet 500A is suppressed.

As shown in FIG. 9 and FIG. 10, depending on the position where the magnetic sheet 510 is diced, a part of the bending suppression portion 550 may remain in a divided product C1, and this remaining part becomes the discrete conductor portion 400 of the coil component 100A. When a first bending suppression portion 550A is provided in the first spiral conductor portion 11, a part of the first bending suppression portion 550A is left by dicing to become a first discrete conductor portion 401, and when a second bending suppression portion 550B is provided in the second spiral conductor portion 21, a part of the second bending suppression portion 550B is left by dicing to become a second discrete conductor portion 402. In the coil component 100A, the corner portions of the rectangular frame (frame-shaped portion) of the bending suppression portion 550 remain at the four corners of the main body portion 30, thereby being configured as rectangular discrete conductor portions 400 when viewed in the first direction (Z1-Z2 direction).

### Other Example: No. 1

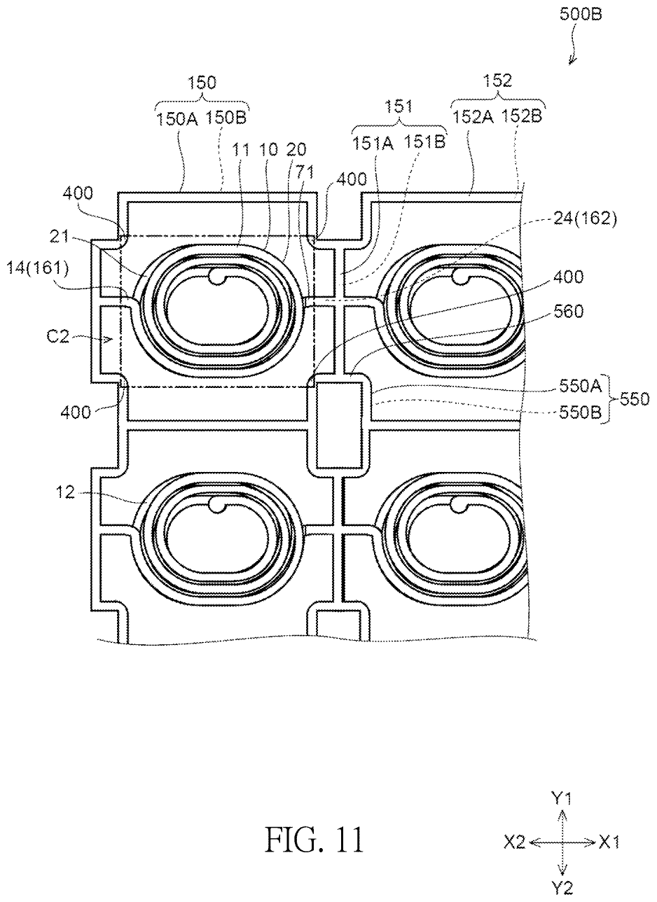

FIG. 11 is a plan view illustrating a coil array sheet according to another example (No. 1). FIG. 12 is a plan view illustrating a coil component according to another example (No. 1). In FIG. 11, a coil array sheet 500B according to another example (No. 1) and a region of one of a plurality of products C2 formed by dividing by dicing are indicated by a two-dot chain line. FIG. 12 is a plan view viewed from the Z1 side in the Z1-Z2 direction, in which the coil conductor portion is drawn by a solid line, and other portions are drawn by broken lines.

In the coil array sheet 500B shown in FIG. 11, a curve is provided at a corner portion of a rectangular frame (frame-shaped portion) of the bending suppression portion 550. As the bending suppression portion 550, at least one of the first bending suppression portion 550A and the second bending suppression portion 550B may be provided. As a result, in the coil component 100B shown in FIG. 12, a discrete conductor portion 400 provided in an arc shape at the four corners of the main body portion 30 is configured when viewed in the first direction (Z1-22 direction). That is, a contact surface between the discrete conductor portion 400 and the main body portion 30 has a curvature toward the corner of the substantially rectangular parallelepiped main body portion 30 within the first surface F1 (see FIG. 5 and FIG. 6).

### Other Example: No. 2

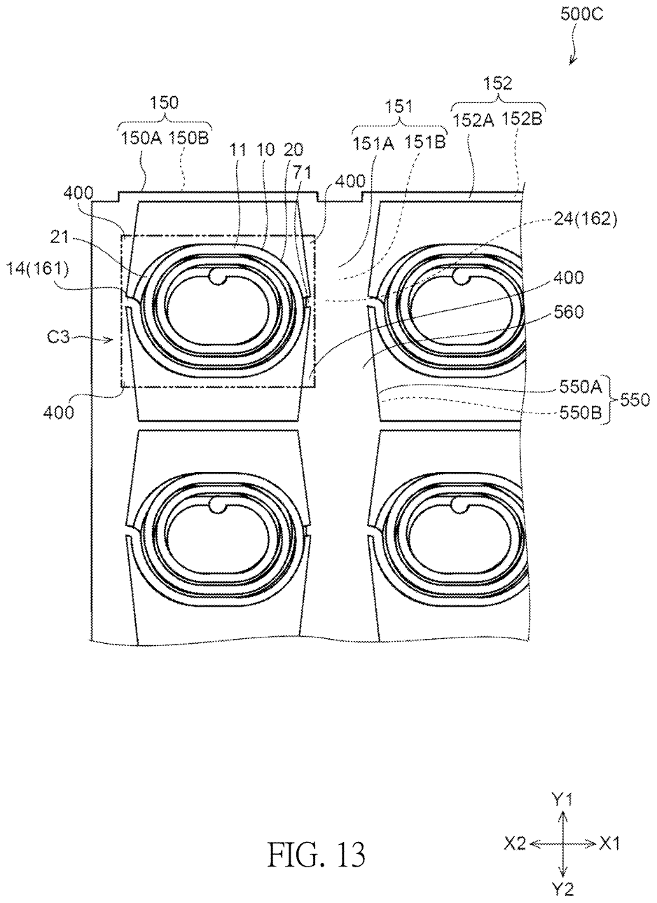

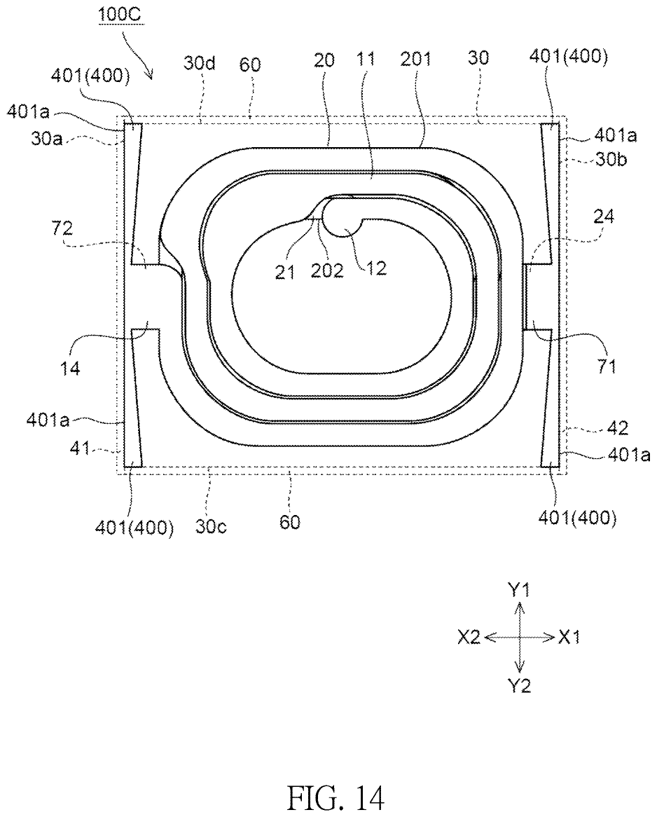

FIG. 13 is a plan view illustrating a coil array sheet according to another example (No. 2). FIG. 14 is a plan view illustrating a coil component according to another example (No. 2). In FIG. 13, a coil array sheet 500C according to another example (No. 2) and a region of one of a plurality of products C3 formed by dividing by dicing are indicated by a two-dot chain line. FIG. 14 is a plan view viewed from the Z1 side in the Z1-Z2 direction, in which the coil conductor portion is drawn by a solid line, and other portions are drawn by broken lines.

In the coil array sheet 500C shown in FIG. 13, the intersection portion 560 of the bending suppression portion 550 is provided non-parallel to the Y1-Y2 direction. As the bending suppression portion 550, at least one of the first bending suppression portion 550A and the second bending suppression portion 550B may be provided. Specifically, an edge of the bridge portion 151 on a side of the coil portion 10 is inclined with respect to the Y1-Y2 direction. As a result, in the coil component 100C shown in FIG. 14, a discrete conductor portion 400 extending from the outer surface 30c to the outer surface 30d is configured on each of the outer surface 30a and the outer surface 30b of the main body portion 30 when viewed in the first direction (Z1-Z2 direction). The inclination of the edge of the bridge portion 151 is left on a side opposite to an exposed surface of each discrete conductor portion 400. That is, both ends of the coil portion 10 become wider in the first surface F1 (see FIG. 5 and FIG. 6) as they get further away from the first spiral conductor portion 11, and become wider in the second surface F2 (see FIG. 5 and FIG. 6) as they get further away from the second spiral conductor portion 21. The portion of the bridge portion 151 that is non-parallel to the Y1-Y2 direction may be linear or curved.

### Other Example: No. 3

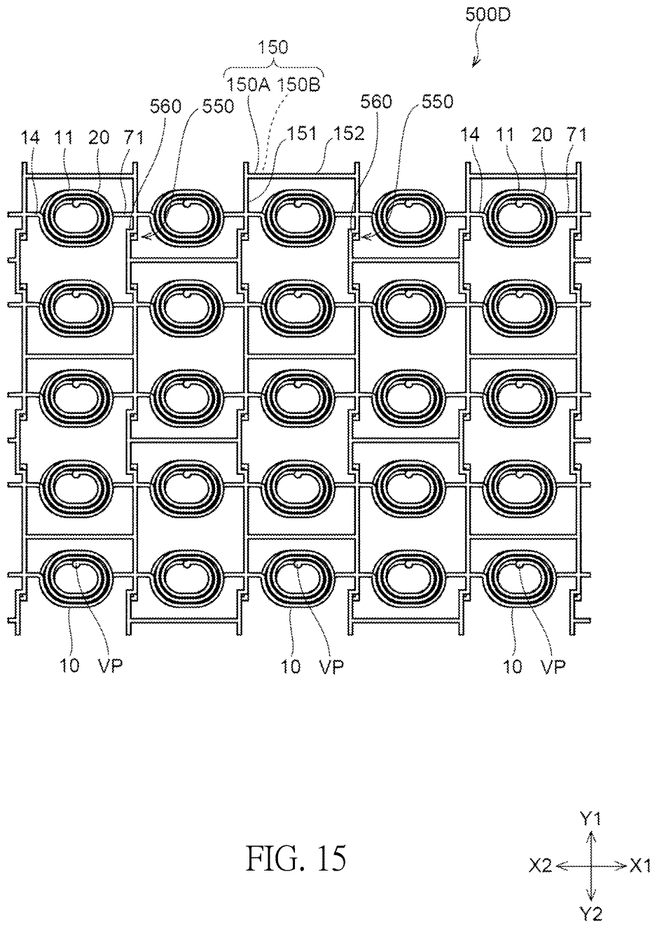

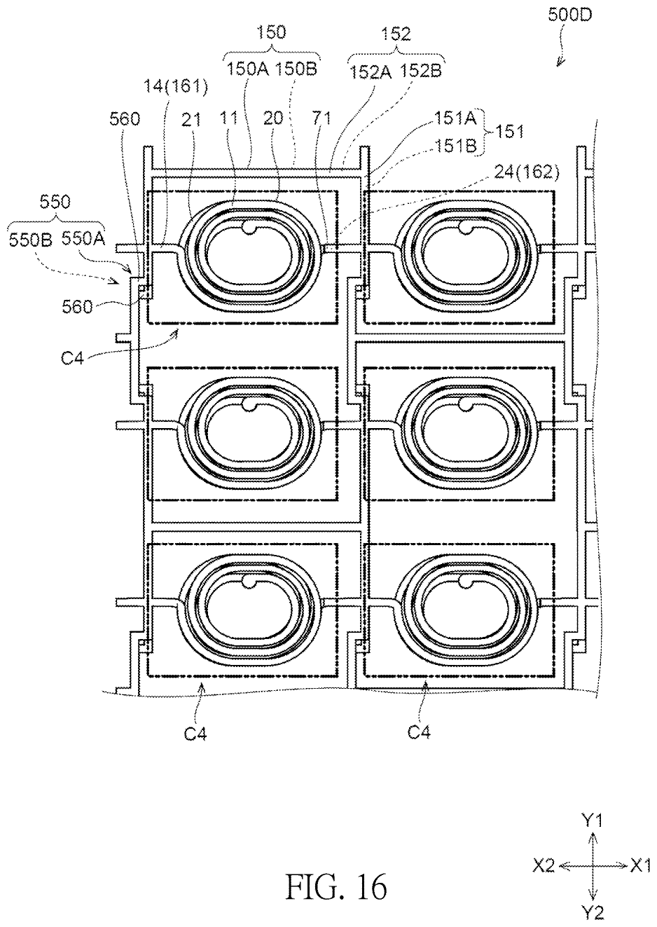

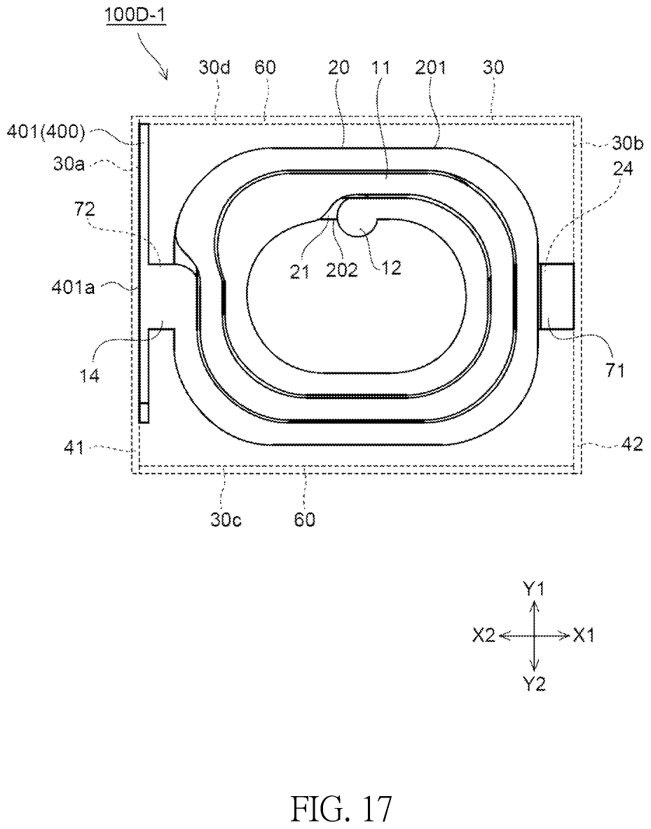

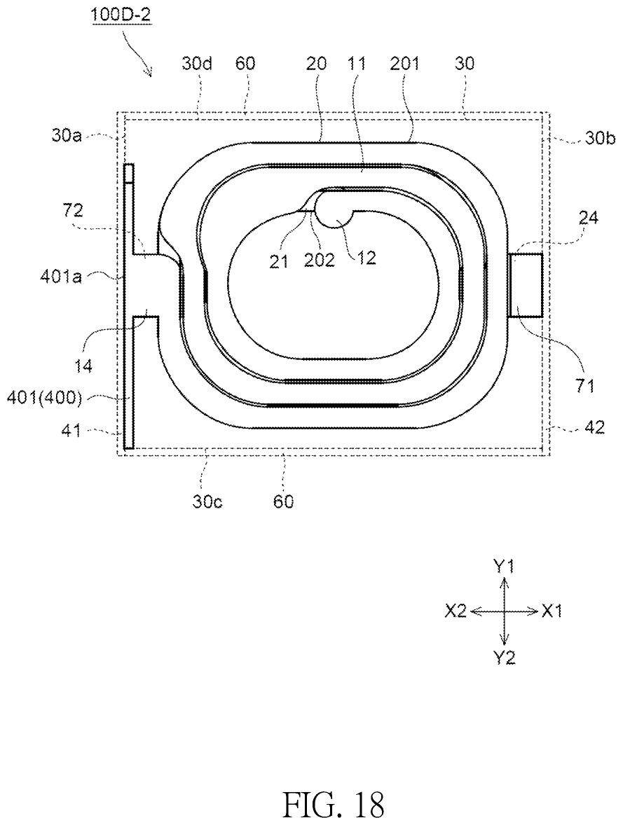

FIG. 15 and FIG. 16 are plan views illustrating a coil array sheet according to another example (No. 3). FIG. 17 and FIG. 18 are plan views illustrating a coil component according to another example (No. 3). In FIG. 16, a coil array sheet 500D according to another example (No. 3) and a region of a plurality of products C4 formed by dividing by dicing are indicated by a two-dot chain line. FIG. 17 and FIG. 18 are plan views viewed from the Z1 side in the Z1-Z2 direction, in which the coil conductor portion is drawn by a solid line, and other portions are drawn by broken lines.

In the coil array sheet 500D shown in FIG. 15 and FIG. 16, the intersection portion 560 of the bending suppression portion 550 is provided as a step structure with respect to the Y1-Y2 direction. As the bending suppression portion 550, at least one of the first bending suppression portion 550A and the second bending suppression portion 550B may be provided. Specifically, a portion bent in the middle of the bridge portion 151 extending in the Y1-Y2 direction and extending in the X1-X2 direction is provided as the intersection portion 560. In the coil array sheet 500D, the bending suppression portion 550 is provided at each bridge portion 151 of the first spiral conductor portion 11 and the second spiral conductor portion 21. When viewed in the first direction (21-22 direction), the intersection portion 560 provided at the bridge portion 151 of the first spiral conductor portion 11 and the intersection portion 560 provided at the bridge portion 151 of the second spiral conductor portion 21 may be provided so as not to overlap each other.

The bending suppression portion 550 is provided correspondingly to every other spacing between adjacent coil portions 10 in the Y1-Y2 direction. Therefore, in the plurality of products C4 divided by dicing, the arrangement of discrete conductor portions 400 configured by a part of the bending suppression portion 550 left in the main body portion 30 becomes line-symmetric in the Y1-Y2 direction. Accordingly, from the coil array sheet 500D, a coil component 100D-1 (see FIG. 17) and a coil component 100D-2 (see FIG. 18), in which arrangements of the discrete conductor portions 400 are line-symmetric to each other, will be manufactured.

### Other Example: No. 4

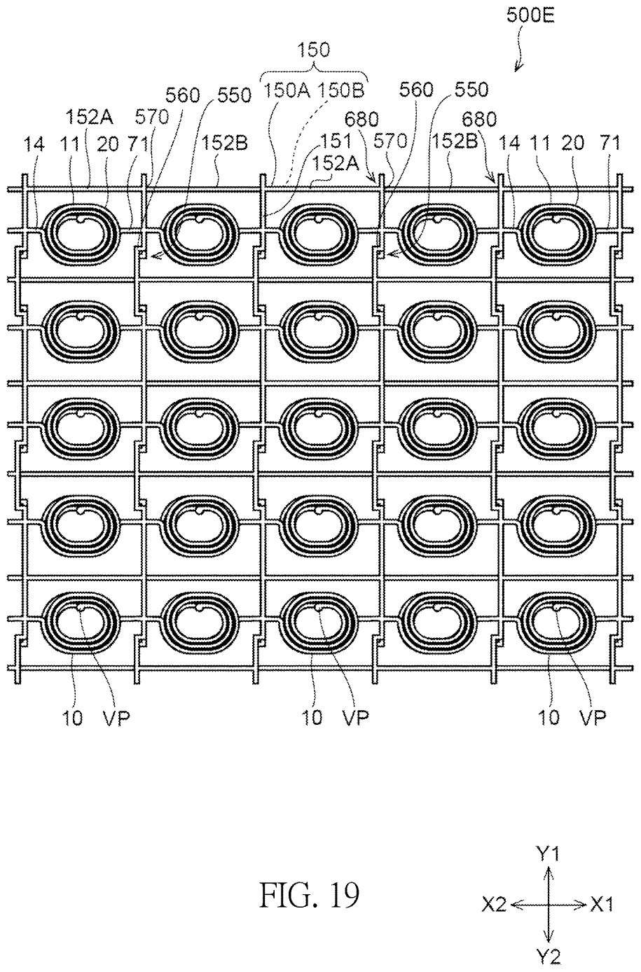

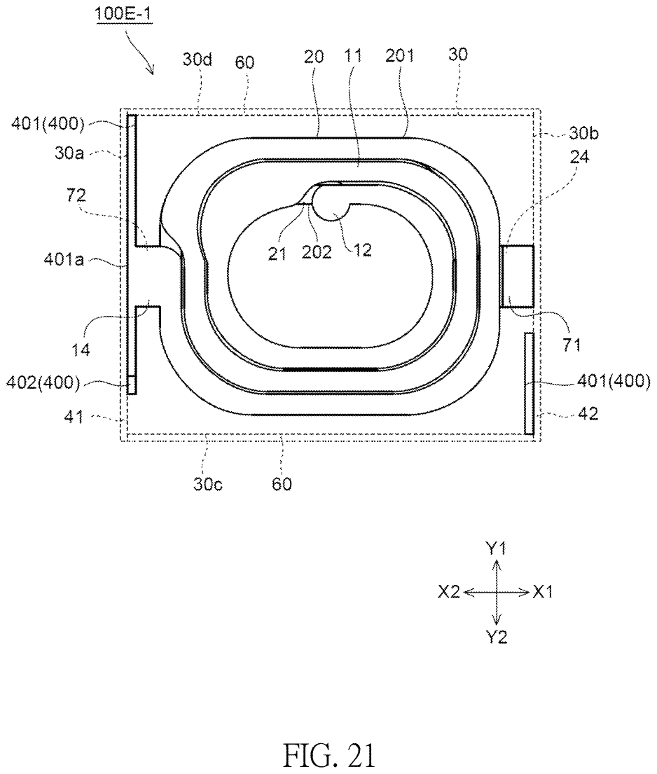

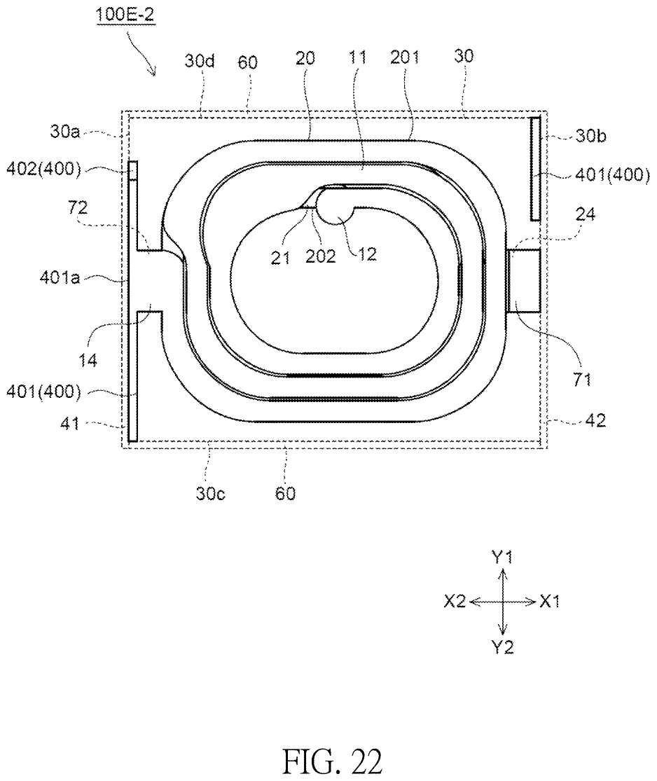

FIG. 19 and FIG. 20 are plan views illustrating a coil array sheet according to another example (No. 4). FIG. 21 and FIG. 22 are plan views illustrating a coil component according to another example (No. 4). In FIG. 20, a coil array sheet 500E according to another example (No. 4) and a region of a plurality of products C5 formed by dividing by dicing are indicated by a two-dot chain line. FIG. 21 and FIG. 22 are plan views viewed from the Z1 side in the Z1-Z2 direction, in which the coil conductor portion is drawn by a solid line, and other portions are drawn by broken lines.

In the coil array sheet 500E shown in FIG. 19 and FIG. 20, similarly to the coil array sheet 500A, the first connecting part 150A has a first closed path, and the second connecting part 150B has a second closed path. In the coil array sheet 500E, the first closed path and the second closed path have an overlapping portion that overlaps when viewed in the first direction, but also have a non-overlapping portion. Therefore, in FIG. 19 and FIG. 20, for the second closed path, only this non-overlapping portion is shown. In the coil array sheet 500E, the bending suppression portion 550 is provided so as to include the above-mentioned overlapping portion, and has a crank portion including an intersection portion 560 bent and extending from a direction, in which the closed path (first closed path, second closed path) extends, and the crank portion is arranged so as to be sandwiched between two overlapping portions when viewed in the first direction.

In the coil array sheet 500E, the intersection portion 560 of the bending suppression portion 550 is provided as a step structure with respect to the Y1-Y2 direction. Specifically, a portion bent in the middle of the bridge portion 151 extending in the Y1-Y2 direction and extending in the X1-X2 direction is provided as the intersection portion 560. As the bending suppression portion 550, both the first bending suppression portion 550A and the second bending suppression portion 550B are provided. When viewed in the first direction (Z1-Z2 direction), the intersection portion 560 provided at the bridge portion 151 of the first spiral conductor portion 11 and the intersection portion 560 provided at the bridge portion 151 of the second spiral conductor portion 21 may be provided so as not to overlap each other.

Furthermore, in the coil array sheet 500E, an auxiliary bending suppression portion 570 that suppresses bending by the first auxiliary bridge portion 152A and the second auxiliary bridge portion 152B is provided. Specifically, an end portion at the X1 side in the X1-X2 direction of the first auxiliary bridge portion 152A and an end portion at the X2 side in the X1-X2 direction of the second auxiliary bridge portion 152B are connected by an intersection portion 680 made of a via connection portion VPC extending in the Z1-Z2 direction (see FIG. 20). As a result, the end portion of the first auxiliary bridge portion 152A extending in the X1-X2 direction and the end portion of the second auxiliary bridge portion 152B extending in the X1-X2 direction form an auxiliary bending suppression portion 570 consisting of a crank structure bent in the Z1-Z2 direction. Bending of the auxiliary bridge portion 152 is suppressed by the auxiliary bending suppression portion 570.

The bending suppression portion 550 is provided correspondingly to every other spacing between adjacent coil portions 10 in the Y1-Y2 direction. Therefore, in the plurality of products C5 divided by dicing, the arrangement of discrete conductor portions 400 configured by a part of the bending suppression portion 550 left in the main body portion 30 becomes line-symmetric in the Y1-Y2 direction. Accordingly, from the coil array sheet 500E, a coil component 100E-1 (see FIG. 21) and a coil component 100E-2 (see FIG. 22) in which arrangements of the discrete conductor portions 400 are line-symmetric to each other will be manufactured. Furthermore, by adjusting cutting width, cutting position, etc. of dicing, the discrete conductor portion 400 may be configured, remaining a part of the bending suppression portion 550 on an outer surface 30b side as well as on an outer surface 30a side of the main body portion 30.

### Other Example: No. 5

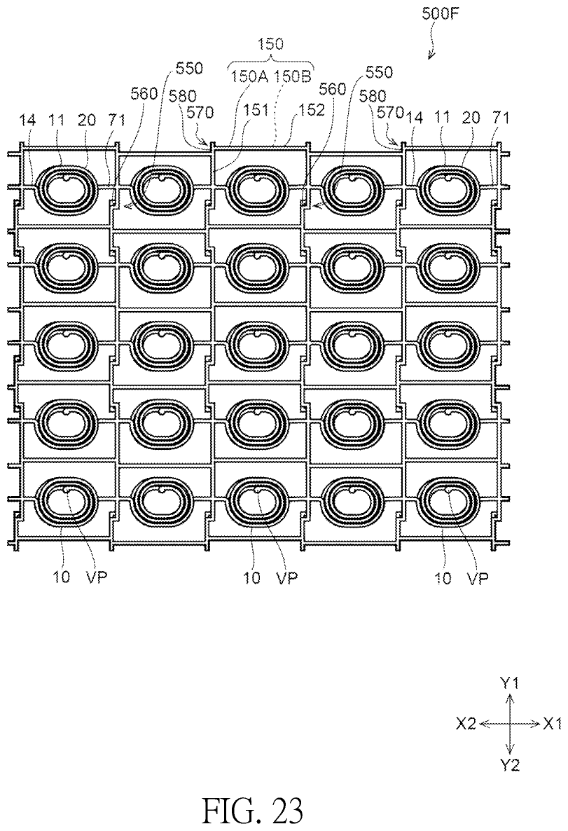

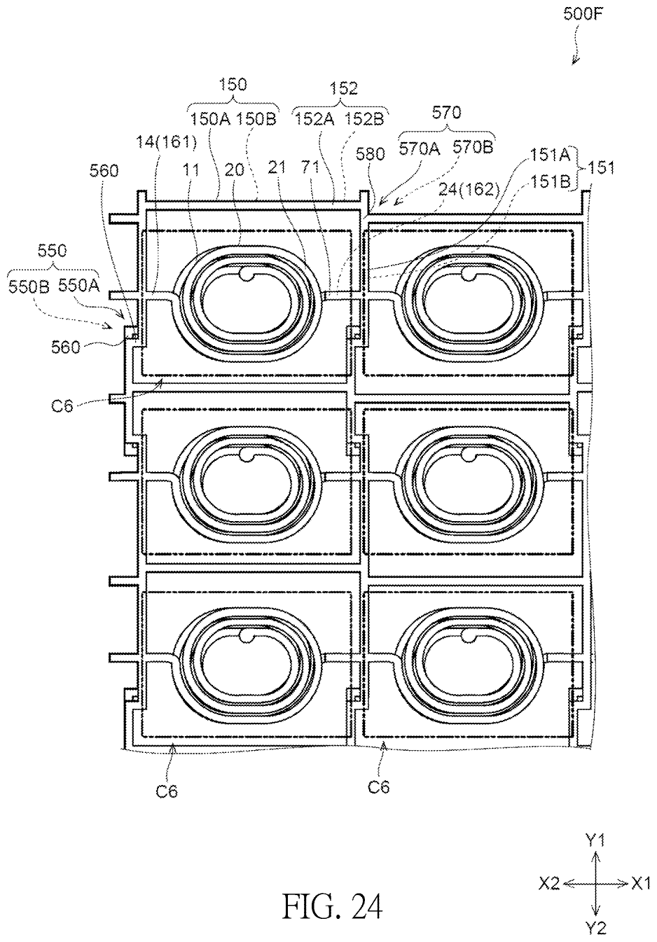

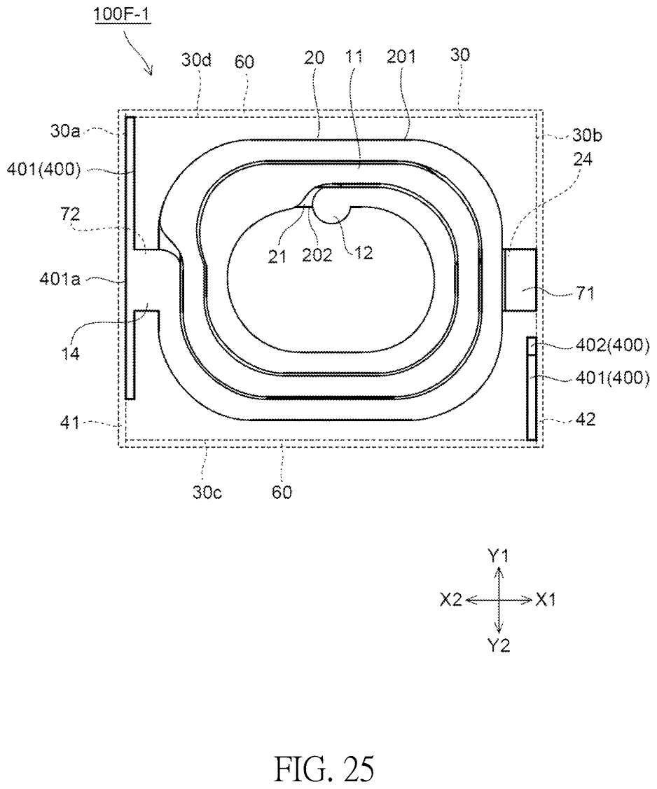

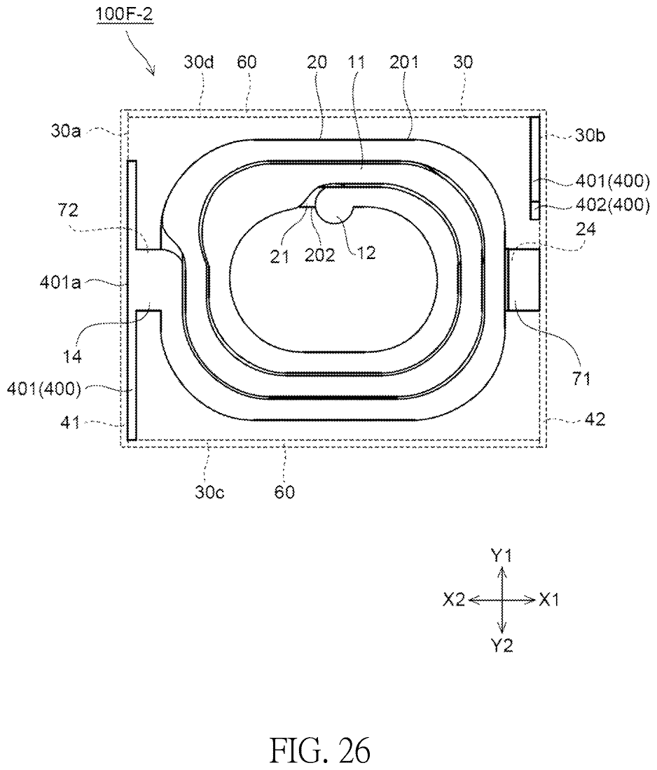

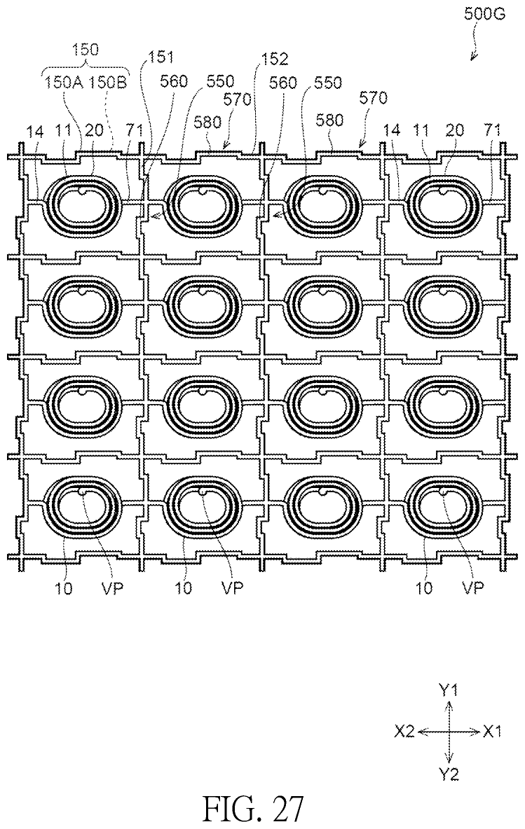

FIG. 23 and FIG. 24 are plan views illustrating a coil array sheet according to another example (No. 5). FIG. 25 and FIG. 26 are plan views illustrating a coil component according to another example (No. 5). In FIG. 24, a coil array sheet 500F according to another example (No. 5) and a region of a plurality of products C6 formed by dividing by dicing are indicated by a two-dot chain line. FIG. 25 and FIG. 26 are plan views viewed from the Z1 side in the Z1-Z2 direction, in which the coil conductor portion is drawn by a solid line, and other portions are drawn by broken lines.

In the coil array sheet 500F shown in FIG. 23 and FIG. 24, the intersection portion 560 of the bending suppression portion 550 is provided as a step structure with respect to the Y1-Y2 direction. As the bending suppression portion 550, at least one of the first bending suppression portion 550A and the second bending suppression portion 550B may be provided. Specifically, a portion bent in the middle of the bridge portion 151 extending in the Y1-Y2 direction and extending in the X1-X2 direction is provided as the intersection portion 560. In the coil array sheet 500F, the bending suppression portion 550 is provided at each bridge portion 151 of the first spiral conductor portion 11 and the second spiral conductor portion 21. When viewed in the first direction (21-22 direction), the intersection portion 560 provided at the bridge portion 151 of the first spiral conductor portion 11 and the intersection portion 560 provided at the bridge portion 151 of the second spiral conductor portion 21 may be provided so as not to overlap each other.

Furthermore, in the coil array sheet 500F, an auxiliary bending suppression portion 570 is provided. An intersection portion 580 of the auxiliary bending suppression portion 570 is provided in the middle of the auxiliary bridge portion 152 extending in the X1-X2 direction as a step structure with respect to the Y1-Y2 direction. As the auxiliary bending suppression portion 570, at least one of a first auxiliary bending suppression portion 570A and a second auxiliary bending suppression portion 570B may be provided. In the present example shown in FIG. 23 and FIG. 24, the auxiliary bending suppression portion 570 is composed of a crank structure formed by an end portion at the X1 side in the X1-X2 direction of the first auxiliary bridge portion 152A extending in the X1-X2 direction, an end portion at the X2 side in the X1-X2 direction of the second auxiliary bridge portion 152B extending in the X1-X2 direction, and an intersection portion 580 formed by a part of the first bridge portion 151A extending in the Y1-Y2 direction located therebetween. In the coil array sheet 500F, the auxiliary bending suppression portion 570 is provided at each auxiliary bridge portion 152 of the first spiral conductor portion 11 and the second spiral conductor portion 21.

The bending suppression portion 550 is provided correspondingly to every other spacing between adjacent coil portions 10 in the Y1-Y2 direction. Therefore, in the plurality of products C6 divided by dicing, the arrangement of discrete conductor portions 400 configured by a part of the bending suppression portion 550 left in the main body portion 30 becomes line-symmetric in the Y1-Y2 direction. Accordingly, from the coil array sheet 500F, a coil component 100F-1 (see FIG. 25) and a coil component 100F-2 (see FIG. 26) in which arrangements of the discrete conductor portions 400 are line-symmetric to each other will be manufactured. Furthermore, by adjusting cutting width, cutting position, etc. of dicing, the discrete conductor portion 400 may be configured, remaining a part of the bending suppression portion 550 on an outer surface 30b side as well as on an outer surface 30a side of the main body portion 30.

### Other Example: No. 6

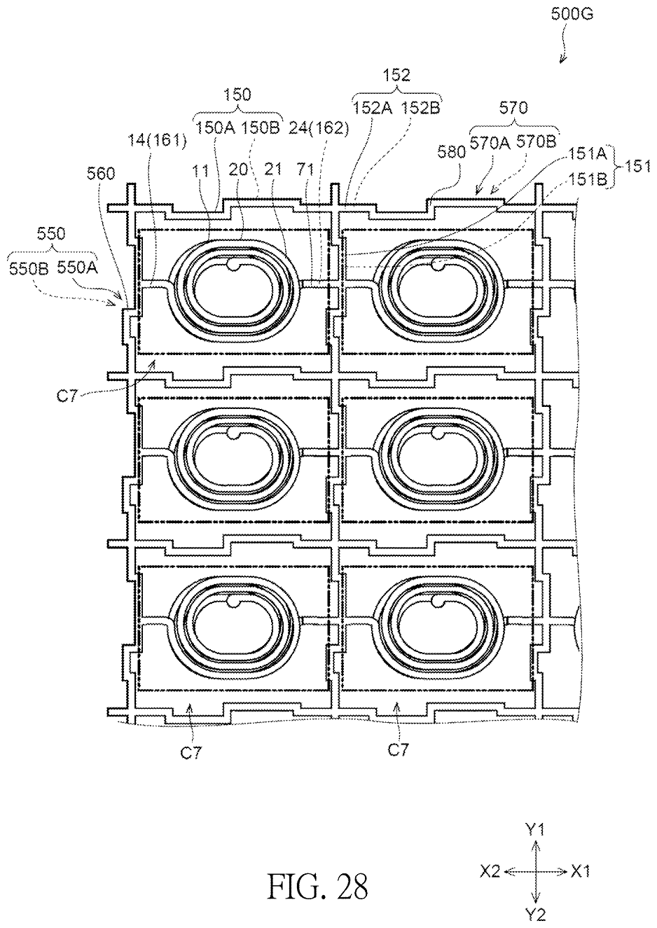

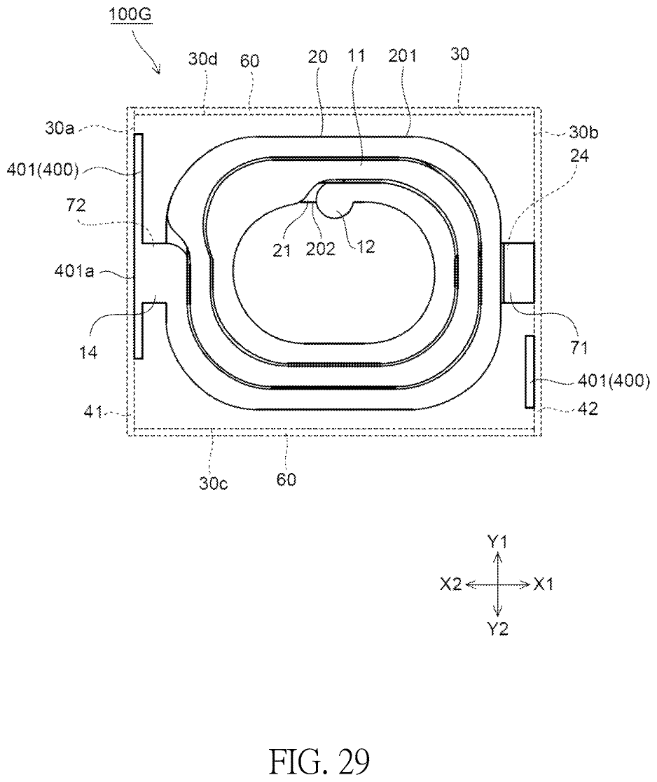

FIG. 27 and FIG. 28 are plan views illustrating a coil array sheet according to another example (No. 6). FIG. 29 is a plan view illustrating a coil component according to another example (No. 6). In FIG. 28, a coil array sheet 500G according to another example (No. 6) and a region of a plurality of products C7 formed by dividing by dicing are indicated by a two-dot chain line. FIG. 29 is a plan view viewed from the Z1 side in the Z1-Z2 direction, in which the coil conductor portion is drawn by a solid line, and other portions are drawn by broken lines.

In the coil array sheet 500G shown in FIG. 27 and FIG. 28, the intersection portion 560 of the bending suppression portion 550 is provided as a step structure with respect to the Y1-Y2 direction. As the bending suppression portion 550, at least one of the first bending suppression portion 550A and the second bending suppression portion 550B may be provided. Specifically, a portion bent in the middle of the bridge portion 151 extending in the Y1-Y2 direction and extending in the X1-X2 direction is provided as the intersection portion 560. In the coil array sheet 500G, the bending suppression portion 550 is provided at each bridge portion 151 of the first spiral conductor portion 11 and the second spiral conductor portion 21.

Furthermore, in the coil array sheet 500G, an auxiliary bending suppression portion 570 is provided. An intersection portion 580 of the auxiliary bending suppression portion 570 is provided in the middle of the auxiliary bridge portion 152 extending in the X1-X2 direction as a step structure with respect to the Y1-Y2 direction. As the auxiliary bending suppression portion 570, at least one of a first auxiliary bending suppression portion 570A and a second auxiliary bending suppression portion 570B may be provided.

Specifically, a portion bent in the middle of the auxiliary bridge portion 152 extending in the X1-X2 direction and extending in the Y1-Y2 direction is provided as the intersection portion 580. In the coil array sheet 500G, the auxiliary bending suppression portion 570 is provided at each auxiliary bridge portion 152 of the first spiral conductor portion 11 and the second spiral conductor portion 21.

The bending suppression portion 550 is provided correspondingly to respective positions of a plurality of coil portions 10 aligned in the Y1-Y2 direction. Therefore, in the plurality of products C7 divided by dicing, arrangements of discrete conductor portions 400 configured by a part of the bending suppression portion 550 left in the main body portion 30 are all the same. Accordingly, a coil component 100G (see FIG. 29) will be manufactured from the coil array sheet 500G. Furthermore, by adjusting cutting width, cutting position, etc. of dicing, the discrete conductor portion 400 may be configured leaving a part of the bending suppression portion 550 on an outer surface 30b side as well as on an outer surface 30a side of the main body portion 30.

### Other Example: No. 7

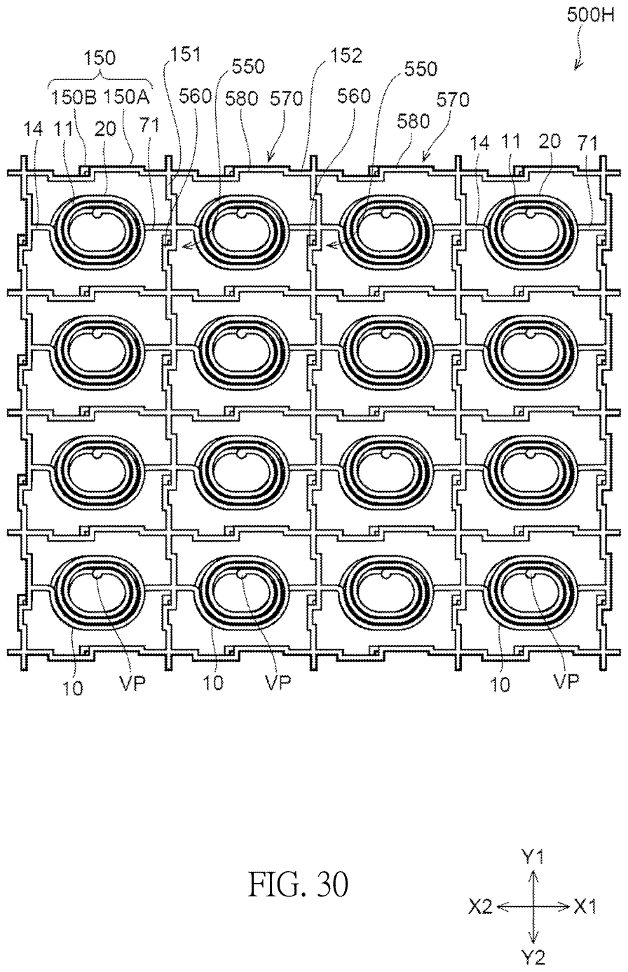

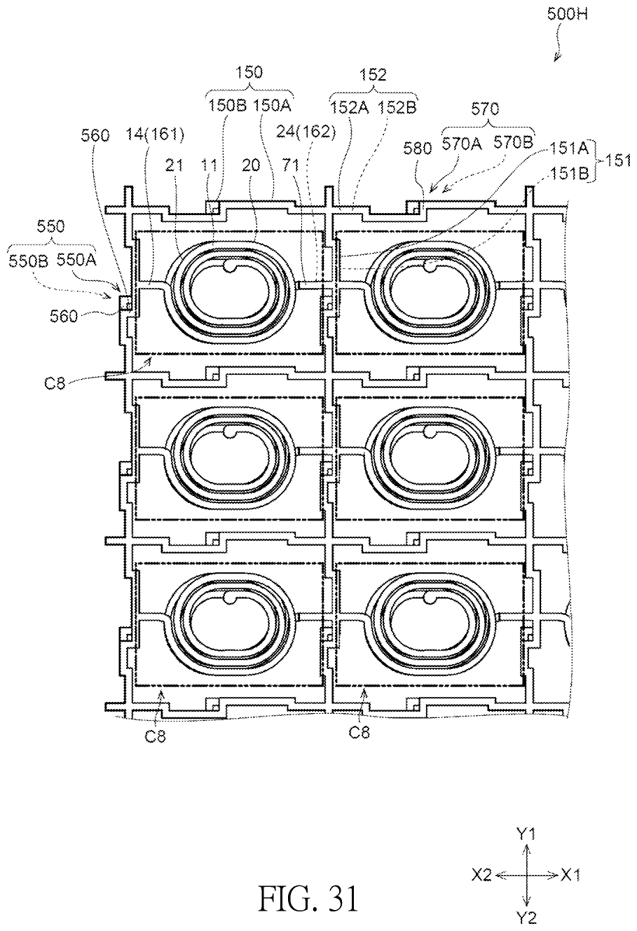

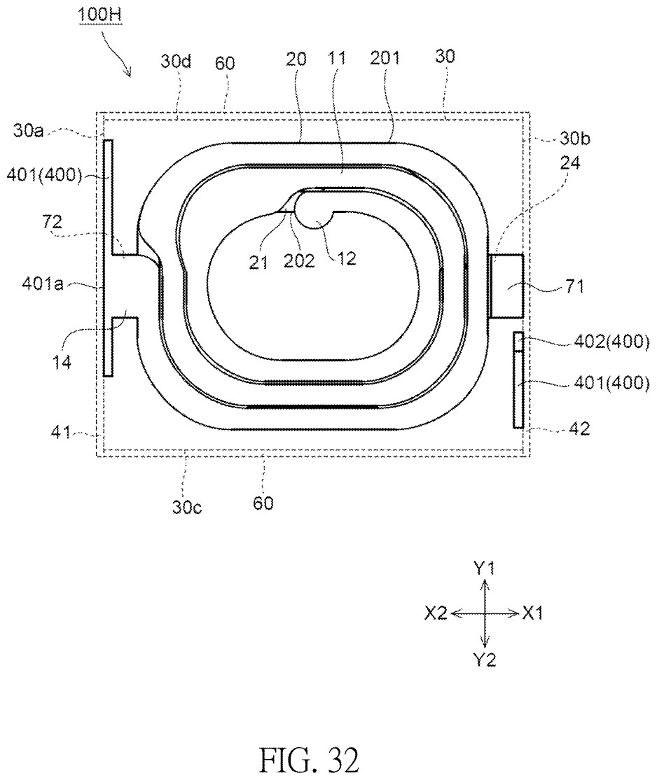

FIG. 30 and FIG. 31 are plan views illustrating a coil array sheet according to another example (No. 7). FIG. 32 is a plan view illustrating a coil component according to another example (No. 7). In FIG. 31, a coil array sheet 500H according to another example (No. 7) and a region of a plurality of products C8 formed by dividing by dicing are indicated by a two-dot chain line. FIG. 32 is a plan view viewed from the Z1 side in the Z1-22 direction, in which the coil conductor portion is drawn by a solid line, and other portions are drawn by broken lines.

In the coil array sheet 500H shown in FIG. 30 and FIG. 31, the intersection portion 560 of the bending suppression portion 550 is provided as a step structure with respect to the Y1-Y2 direction. As the bending suppression portion 550, at least one of the first bending suppression portion 550A and the second bending suppression portion 550B may be provided. Specifically, a portion bent in the middle of the bridge portion 151 extending in the Y1-Y2 direction and extending in the X1-X2 direction is provided as the intersection portion 560. In the coil array sheet 500H, the bending suppression portion 550 is provided at each bridge portion 151 of the first spiral conductor portion 11 and the second spiral conductor portion 21. In addition, when viewed in the first direction (Z1-Z2 direction), the intersection portion 560 provided at the bridge portion 151 of the first spiral conductor portion 11 and the intersection portion 560 provided at the bridge portion 151 of the second spiral conductor portion 21 are provided so as not to overlap each other.

Furthermore, in the coil array sheet 500H, an auxiliary bending suppression portion 570 is provided. An intersection portion 580 of the auxiliary bending suppression portion 570 is provided in the middle of the auxiliary bridge portion 152 extending in the X1-X2 direction as a step structure with respect to the Y1-Y2 direction. As the auxiliary bending suppression portion 570, at least one of a first auxiliary bending suppression portion 570A and a second auxiliary bending suppression portion 570B may be provided.

Specifically, a portion bent in the middle of the auxiliary bridge portion 152 extending in the X1-X2 direction and extending in the Y1-Y2 direction is provided as the intersection portion 580. In the coil array sheet 500H, the auxiliary bending suppression portion 570 is provided at each auxiliary bridge portion 152 of the first spiral conductor portion 11 and the second spiral conductor portion 21. In addition, when viewed in the first direction (Z1-Z2 direction), the intersection portion 580 provided at the auxiliary bridge portion 152 of the first spiral conductor portion 11 and the intersection portion 580 provided at the auxiliary bridge portion 152 of the second spiral conductor portion 21 are provided so as not to overlap each other.

The bending suppression portion 550 is provided correspondingly to respective positions of a plurality of coil portions 10 aligned in the Y1-Y2 direction. Therefore, in the plurality of products C8 divided by dicing, arrangements of discrete conductor portions 400 configured by a part of the bending suppression portion 550 left in the main body portion 30 are all the same. Accordingly, a coil component 100H (see FIG. 32) will be manufactured from the coil array sheet 500H. Furthermore, by adjusting cutting width, cutting position, etc. of dicing, the discrete conductor portion 400 may be configured, remaining a part of the bending suppression portion 550 on an outer surface 30b side as well as on an outer surface 30a side of the main body portion 30.

### Other Example: No. 8

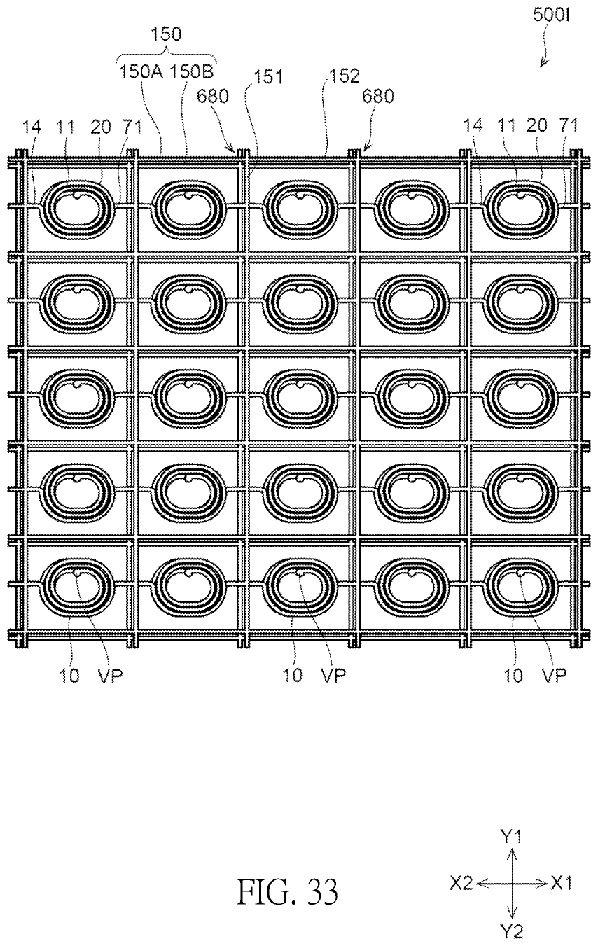

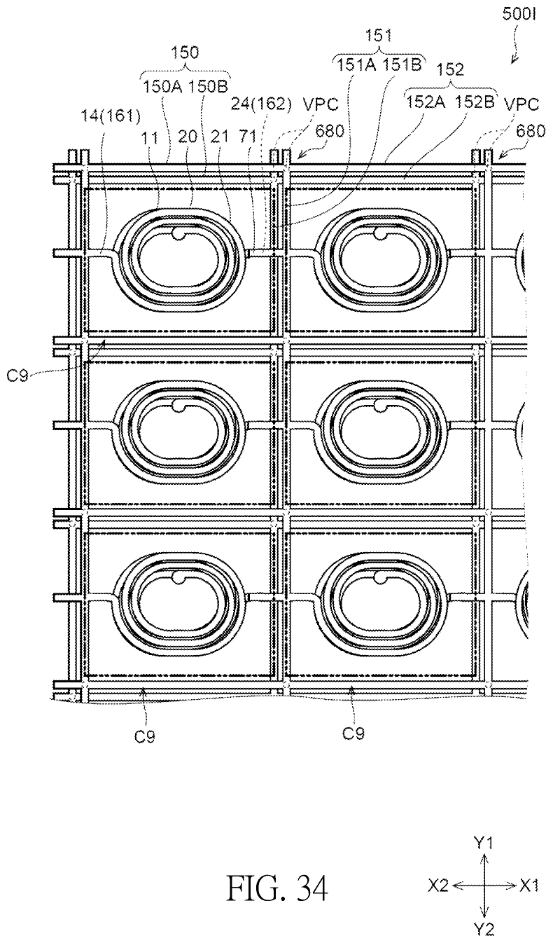

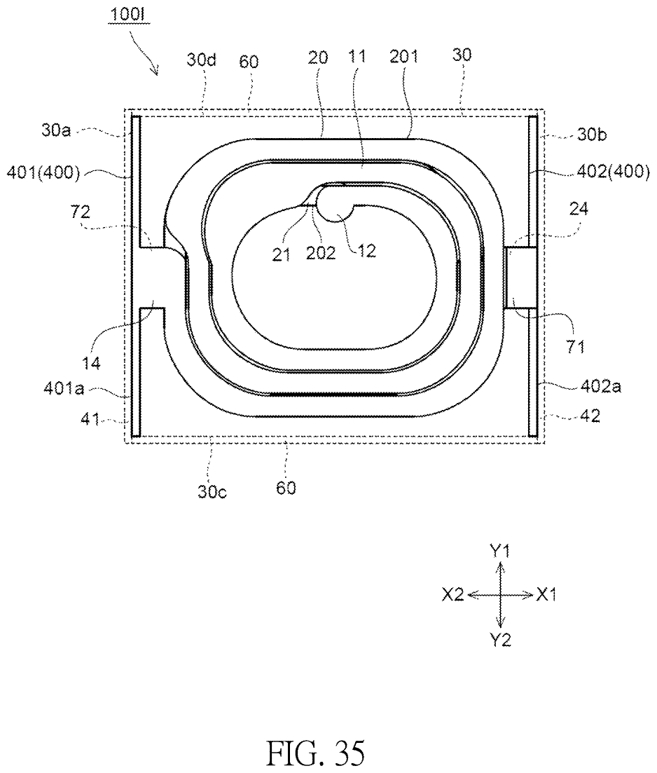

FIG. 33 and FIG. 34 are plan views illustrating a coil array sheet according to another example (No. 8). FIG. 35 is a plan view illustrating a coil component according to another example (No. 8). In FIG. 34, a coil array sheet 500I according to another example (No. 8) and a region of a plurality of products C9 formed by dividing by dicing are indicated by a two-dot chain line. FIG. 35 is a plan view viewed from the Z1 side in the Z1-Z2 direction, in which the coil conductor portion is drawn by a solid line, and other portions are drawn by broken lines.

In the coil array sheet 500I shown in FIG. 33 and FIG. 34, the first connecting part 150A and the second connecting part 150B are misaligned in the X1-X2 direction and the Y1-Y2 direction when viewed in the first direction. Specifically, relative to the first bridge portion 151A, the second bridge portion 151B is located on the X2 side in the X1-X2 direction, and relative to the first auxiliary bridge portion 152A, the second auxiliary bridge portion 152B is located on the Y2 side in the Y1-Y2 direction. The first bridge portion 151A and the second auxiliary bridge portion 152B have an overlapping portion in the Z1-22 direction, and a via connection portion VPC connecting the first bridge portion 151A and the second auxiliary bridge portion 152B is located at this portion. Also, the first auxiliary bridge portion 152A and the second bridge portion 151B have an overlapping portion in the Z1-Z2 direction, and a via connection portion VPC connecting the first auxiliary bridge portion 152A and the second bridge portion 151B is located at this portion. Then, an intersection portion 680 consisting of the first bridge portion 151A and the via connection portion VPC and the second auxiliary bridge portion 152B form a crank portion consisting of the Y1-Y2 direction, the Z1-Z2 direction, and the X1-X2 direction, and an intersection portion 680 consisting of the first auxiliary bridge portion 152A and the via connection portion VPC and the second bridge portion 151B form a crank portion consisting of the X1-X2 direction, the Z1-Z2 direction, and the Y1-Y2 direction.

In the coil array sheet 500I, compared with the coil array sheets in the other examples, an area where the first connecting part 150A and the second connecting part 150B do not overlap when viewed in the first direction (Z1-Z2 direction) is larger. With such a configuration, in the structure a giving the coil array sheet 500I, a portion substantially formed from the substrate (substrate portion) is less likely to be formed, and most of it becomes a negative pattern portion in which a negative pattern is provided on at least one surface. Therefore, in the structure a giving the coil array sheet 500I, defects caused by a narrowed width of the conductor formed from plated deposits due to bending of the substrate portion are less likely to occur. Therefore, in the coil component 100I formed from the coil array sheet 500I (see FIG. 35), the magnetic and electrical properties are particularly less likely to deteriorate.

In the plurality of products C9 divided by dicing, arrangements of discrete conductor portions 400 configured by a part of the bending suppression portion 550 left in the main body portion 30 are all the same. Accordingly, a coil component 100I (see FIG. 35) will be produced from the coil array sheet 500I. Furthermore, by adjusting cutting width, cutting position, etc. of dicing, the discrete conductor portion 400 may be configured, remaining a part of the bending suppression portion 550 on an outer surface 30b side as well as on an outer surface 30a side of the main body portion 30.

### Other Example: No. 9

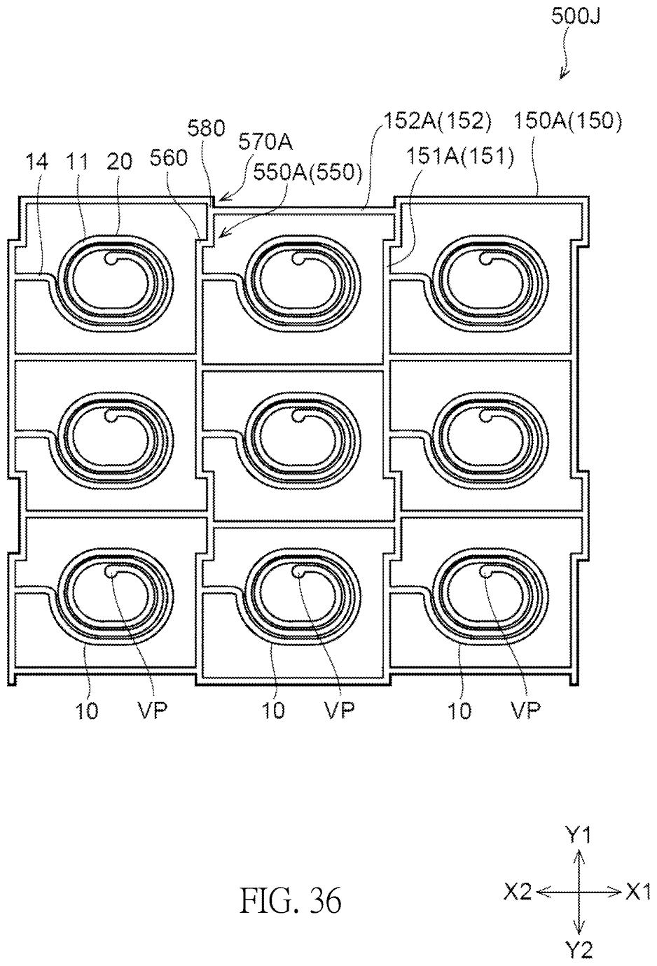

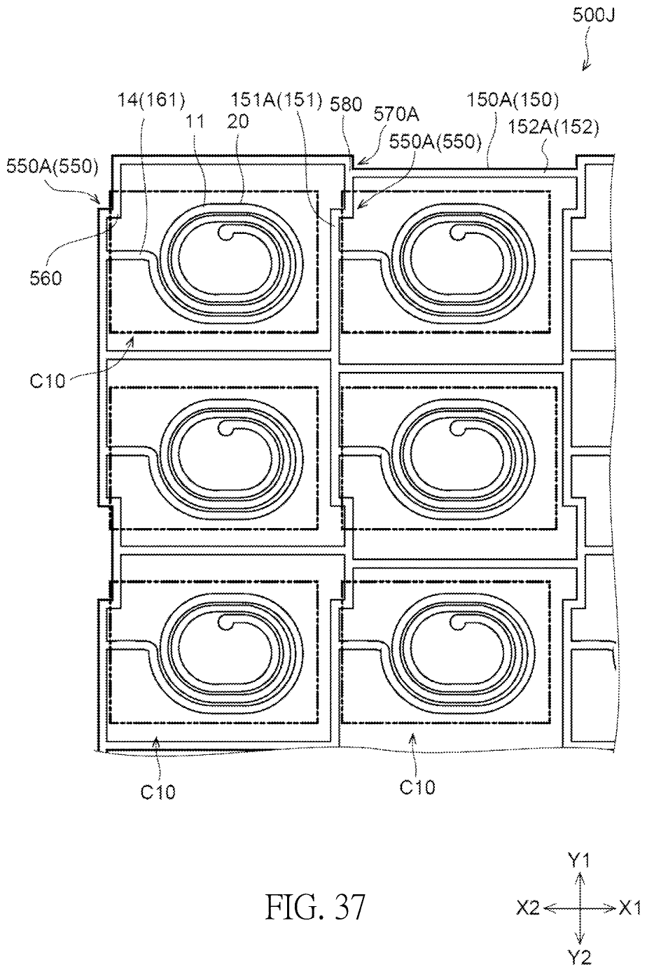

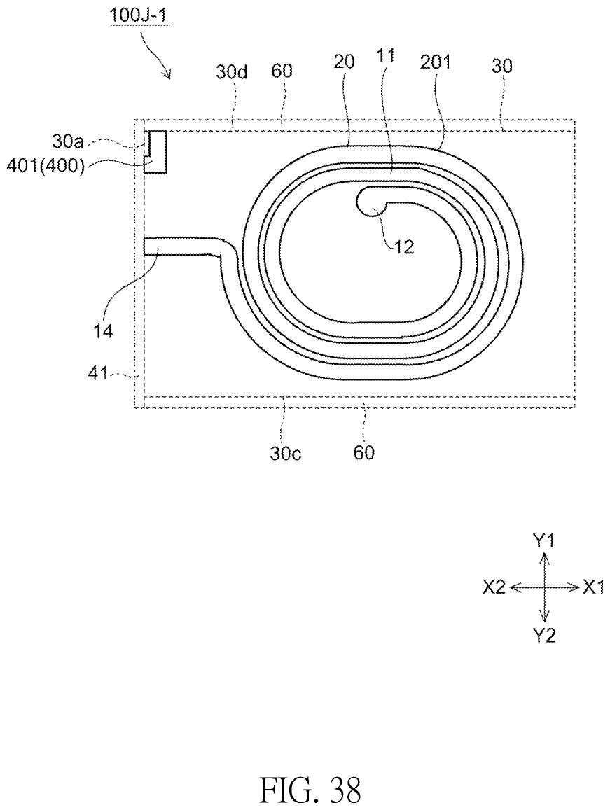

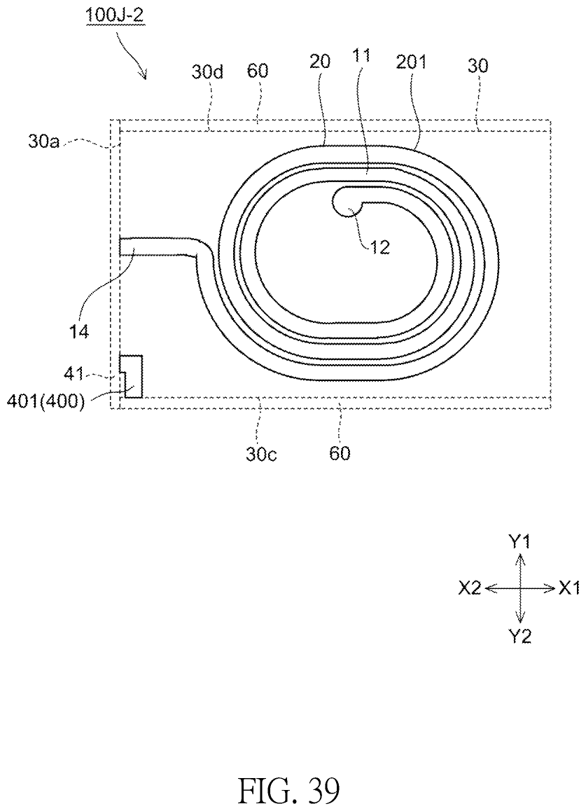

FIG. 36 and FIG. 37 are plan views illustrating a coil array sheet according to another example (No. 9). FIG. 38 and FIG. 39 are plan views illustrating a coil component according to another example (No. 9). In FIG. 37, a coil array sheet 500J according to another example (No. 9) and a region of a plurality of products C10 formed by dividing by dicing are indicated by a two-dot chain line. FIG. 38 and FIG. 39 are plan views viewed from the Z1 side in the Z1-Z2 direction, in which the coil conductor portion is drawn by a solid line, and other portions are drawn by broken lines.

In the coil array sheet 500J shown in FIG. 36 and FIG. 37, the intersection portion 560 of the bending suppression portion 550 is provided as a step structure with respect to the Y1-Y2 direction. Specifically, a portion bent in the middle of the bridge portion 151 extending in the Y1-Y2 direction and extending in the X1-X2 direction is provided as the intersection portion 560. The coil array sheet 500J has only the first spiral conductor portion 11. Therefore, only the first bending suppression portion 550A is provided as the bending suppression portion 550. The intersection portion 560, which is a portion bent in the middle of the first bridge portion 151A and extending in the X1-X2 direction, is aligned with a position of a corner portion of the main body portion 30 formed by dicing.

Furthermore, in the coil array sheet 500J, a first auxiliary bending suppression portion 570A is provided. An intersection portion 580 of the first auxiliary bending suppression portion 570A is provided in the middle of the first auxiliary bridge portion 152A extending in the X1-X2 direction as a step structure with respect to the Y1-Y2 direction. Specifically, a portion bent in the middle of the first auxiliary bridge portion 152A extending in the X1-X2 direction and extending in the Y1-Y2 direction is provided as the intersection portion 580.

The first bending suppression portion 550A is provided correspondingly to every other spacing between adjacent coil portions 10 in the Y1-Y2 direction. Therefore, in the plurality of products C10 divided by dicing, an arrangement of discrete conductor portions 400 (first discrete conductor portion 401) configured by a part of the first bending suppression portion 550A left in the main body portion 30 becomes line-symmetric in the Y1-Y2 direction.

Accordingly, from the coil array sheet 500J, a coil component 100J-1 (see FIG. 38) and a coil component 100J-2 (see FIG. 39) in which arrangements of the discrete conductor portions 400 (first discrete conductor portion 401) are line-symmetric to each other will be manufactured. Furthermore, by adjusting cutting width, cutting position, etc. of dicing, the discrete conductor portion 400 may be configured, remaining a part of the bending suppression portion 550 on an outer surface 30b side as well as on an outer surface 30a side of the main body portion 30.

### Other Example: No. 10

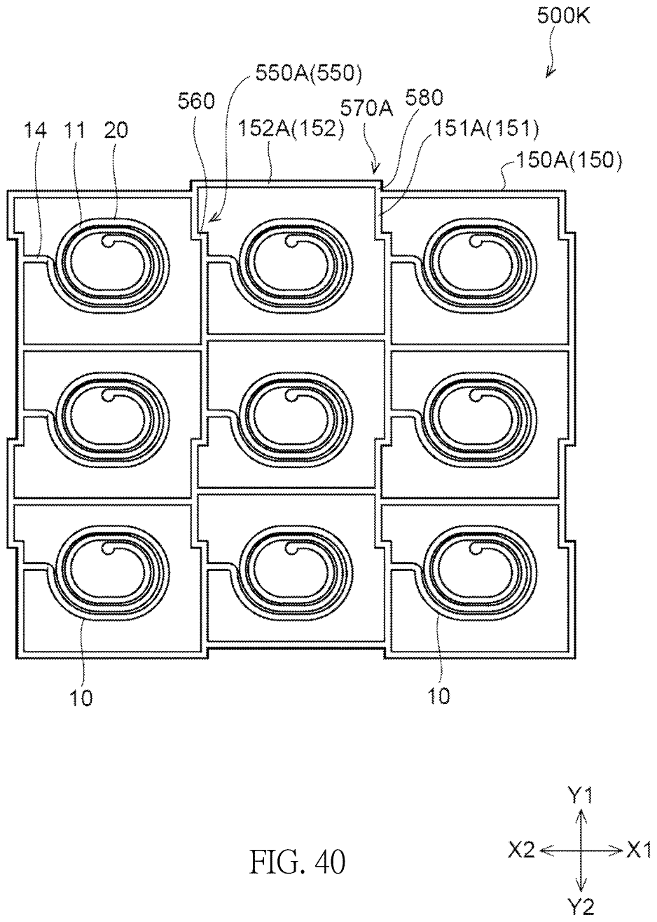

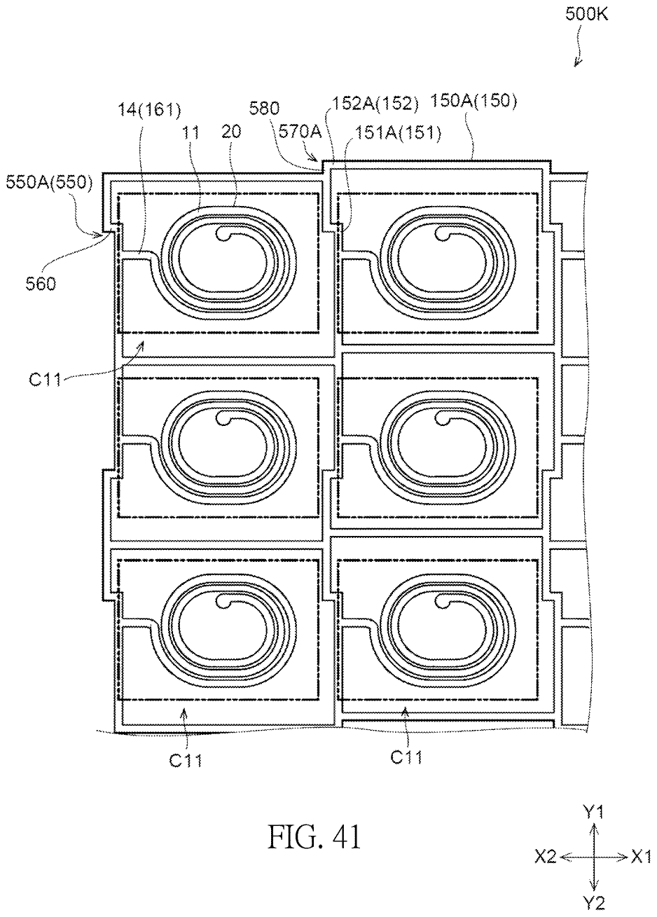

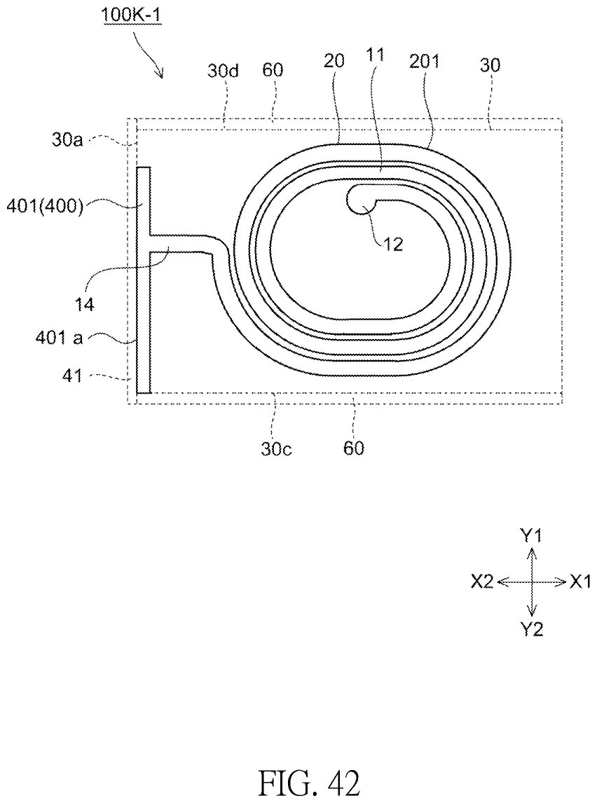

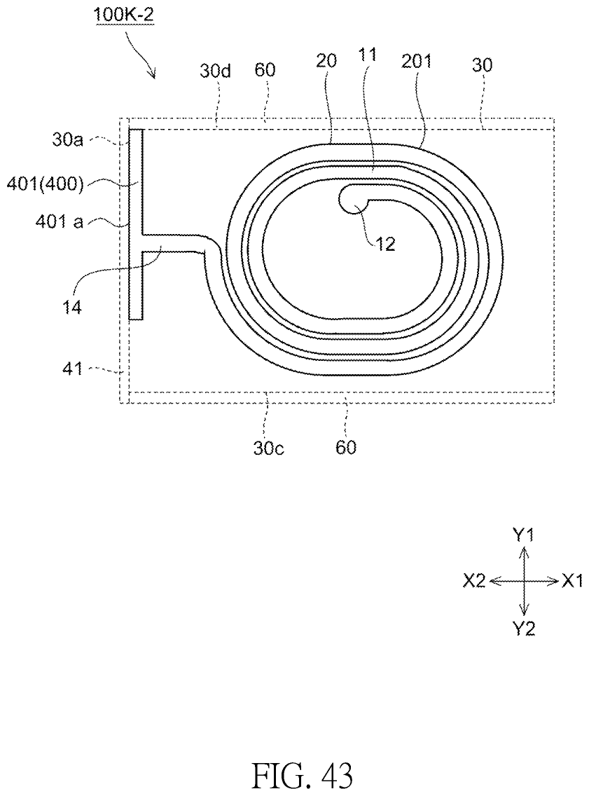

FIG. 40 and FIG. 41 are plan views illustrating a coil array sheet according to another example (No. 10). FIG. 42 and FIG. 43 are plan views illustrating a coil component according to another example (No. 10). In FIG. 41, a coil array sheet 500K according to another example (No. 10) and a region of a plurality of products C11 formed by dividing by dicing are indicated by a two-dot chain line. FIG. 42 and FIG. 43 are plan views viewed from the Z1 side in the Z1-Z2 direction, in which the coil conductor portion is drawn by a solid line, and other portions are drawn by broken lines.

In the coil array sheet 500K shown in FIG. 40 and FIG. 41, the intersection portion 560 of the bending suppression portion 550 is provided as a step structure with respect to the Y1-Y2 direction. Specifically, a portion bent in the middle of the bridge portion 151 extending in the Y1-Y2 direction and extending in the X1-X2 direction is provided as the intersection portion 560. The coil array sheet 500K has only the first spiral conductor portion 11. Therefore, only the first bending suppression portion 550A is provided as the bending Suppression portion 550. The intersection portion 560, which is a portion bent in the middle of the first bridge portion 151A and extending in the X1-X2 direction, is aligned with a position along the outer surface 30a of the main body portion 30 formed by dicing.

Furthermore, in the coil array sheet 500K, a first auxiliary bending suppression portion 570A is provided. An intersection portion 580 of the first auxiliary bending suppression portion 570A is provided in the middle of the first auxiliary bridge portion 152A extending in the X1-X2 direction as a step with respect to the Y1-Y2 direction. Specifically, a portion bent in the middle of the first auxiliary bridge portion 152A extending in the X1-X2 direction and extending in the Y1-Y2 direction is provided as the intersection portion 580.

The first bending suppression portion 550A is provided correspondingly to every other spacing between adjacent coil portions 10 in the Y1-Y2 direction. Therefore, in the plurality of products C11 divided by dicing, an arrangement of discrete conductor portions 400 (first discrete conductor portion 401) configured by a part of the first bending suppression portion 550A left in the main body portion 30 becomes line-symmetric in the Y1-Y2 direction.

Accordingly, from the coil array sheet 500K, a coil component 100K-1 (see FIG. 42) and a coil component 100K-2 (see FIG. 43) in which arrangements of the discrete conductor portions 400 (first discrete conductor portion 401) are line-symmetric to each other will be manufactured. Furthermore, by adjusting cutting width, cutting position, etc. of dicing, the discrete conductor portion 400 may be configured leaving a part of the bending suppression portion 550 on an outer surface 30b side as well as on an outer surface 30a side of the main body portion 30.

### Other Example: No. 11

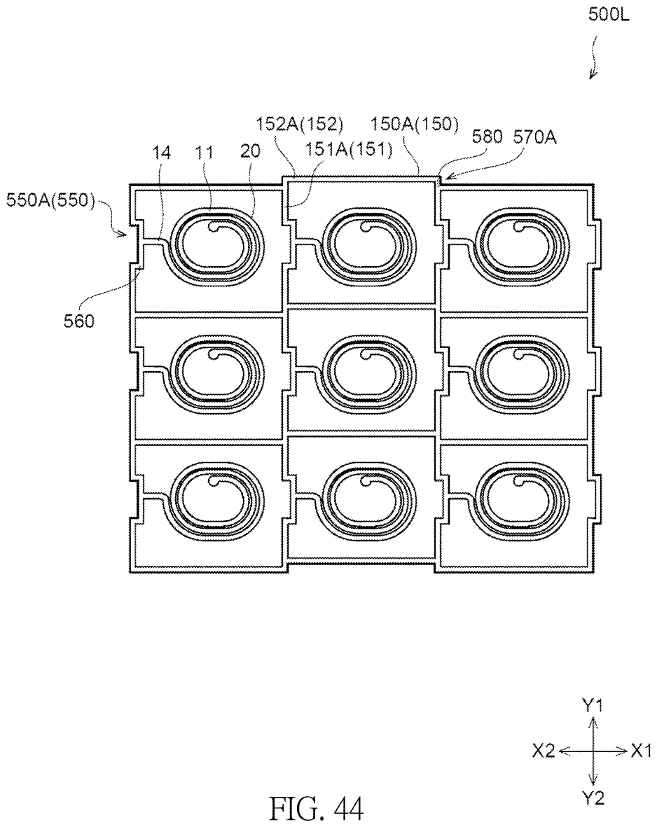

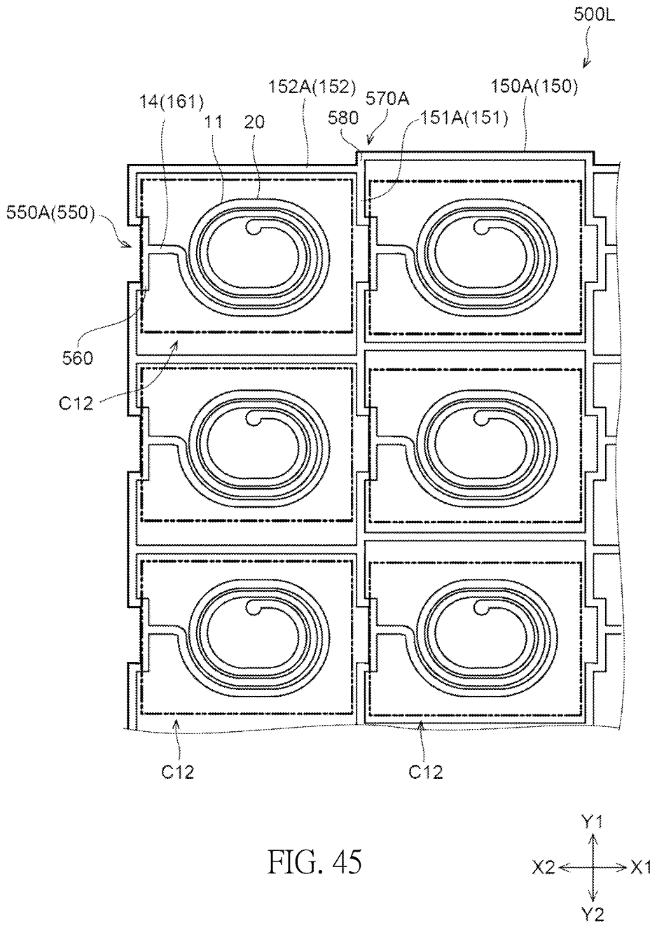

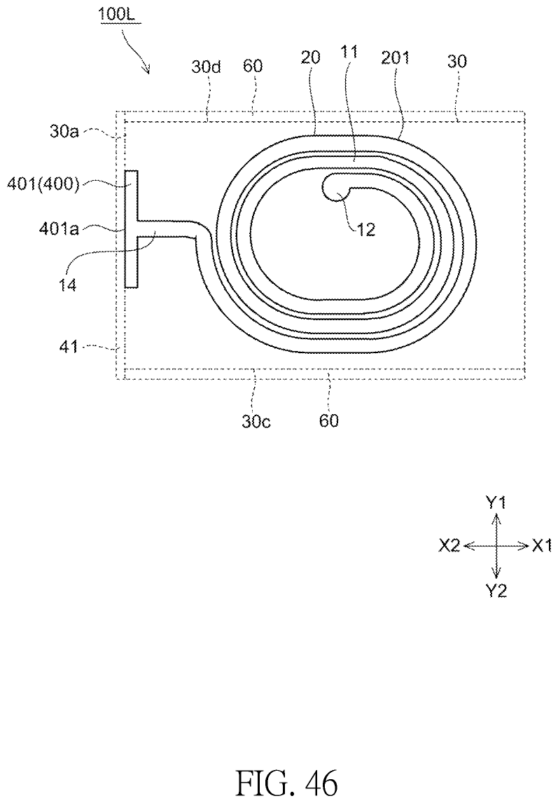

FIG. 44 and FIG. 45 are plan views illustrating a coil array sheet according to another example (No. 11). FIG. 46 is a plan view illustrating a coil component according to another example (No. 10). In FIG. 45, a coil array sheet 500L according to another example (No. 10) and a region of a plurality of products C12 formed by dividing by dicing are indicated by a two-dot chain line. FIG. 46 is a plan view viewed from the Z1 side in the Z1-Z2 direction, in which the coil conductor portion is drawn by a solid line, and other portions are drawn by broken lines.

In the coil array sheet 500L shown in FIG. 44 and FIG. 45, the intersection portion 560 of the bending suppression portion 550 is provided as a step structure with respect to the Y1-Y2 direction. Specifically, a portion bent in the middle of the bridge portion 151 extending in the Y1-Y2 direction and extending in the X1-X2 direction is provided as the intersection portion 560. The coil array sheet 500L has only the first spiral conductor portion 11. Therefore, only the first bending suppression portion 550A is provided as the bending suppression portion 550. The intersection portion 560, which is a portion bent in the middle of the first bridge portion 151A and extending in the X1-X2 direction, is aligned along the outer surface 30a of the main body portion 30 formed by dicing and matched to a central portion in the Y1-Y2 direction.

Furthermore, in the coil array sheet 500L, a first auxiliary bending suppression portion 570A is provided. An intersection portion 580 of the first auxiliary bending suppression portion 570A is provided in the middle of the first auxiliary bridge portion 152A extending in the X1-X2 direction as a step with respect to the Y1-Y2 direction. Specifically, a portion bent in the middle of the first auxiliary bridge portion 152A extending in the X1-X2 direction and extending in the Y1-Y2 direction is provided as the intersection portion 580.

### The First Bending Suppression Portion 550a Is Provided

correspondingly to respective positions of a plurality of coil portions 10 aligned in the Y1-Y2 direction. Therefore, in the plurality of products C12 divided by dicing, arrangements of discrete conductor portions 400 (first discrete conductor portion 401) configured by a part of the first bending suppression portion 550A left in the main body portion 30 are all the same. Accordingly, a coil component 100L (see FIG. 46) will be manufactured from the coil array sheet 500L. Furthermore, by adjusting cutting width, cutting position, etc. of dicing, the discrete conductor portion 400 (first discrete conductor portion 401) may be configured, remaining a part of the bending suppression portion 550 on an outer surface 30b side as well as on an outer surface 30a side of the main body portion 30.

According to the method for manufacturing a coil component using the coil array sheets 500A to 500L described above, by providing the bending suppression portion 550, even if stress is applied to the coil array sheets 500A to 500L during the manufacturing process, deformation due to bending can be suppressed, and positional displacement of each coil portion 10 in the coil array sheets 500A to 500L is effectively suppressed. Moreover, by providing the first discrete conductor portion 401 in the main body portion 30, tightness of the first terminal member 41 to the main body portion 30 is improved, and by providing the second discrete conductor portion 402, tightness of the second terminal member 42 to the main body portion 30 is improved.

In the above manufacturing method, the connecting part 150 may be cut off without being left in the main body portion 30 by adjusting the cutting width, cutting position, etc. of dicing. In this case, although a part of the connecting part 150 does not remain in the main body portion 30, a part of the connecting part 150 may be included in the remaining portion that does not become the coil component.

### Electronic/Electric Device

An electronic/electric device according to an embodiment of the present invention is an electronic/electric device in which the coil components 100A to 100L according to the embodiment of the present invention are mounted, and the coil components 100A to 100L are connected to a board at terminal portions (such as the first terminal member 41) provided at both ends of the coil portion 10 exposed from the main body portion 30. Since the electronic/electric device according to the embodiment of the present invention has the coil components 100A to 100L according to the embodiment of the present invention mounted therein, connection stability and connection reliability of the coil components 100A to 100L to the electronic/electric device are high, and the reliability of the electronic/electric device can be improved. Further, since the coil components 100A to 100L can easily accommodate high-density mounting, devices equipped with them can be particularly easily miniaturized. Furthermore, even if a large current flows or a high frequency is applied in the device, failures caused by functional degradation or heat generation of the coil components 100A to 100L are less likely to occur The embodiments and examples described above have been described for the purpose of facilitating the understanding of the present invention, and are not described for the purpose of limiting the present invention. Therefore, each element disclosed in the above embodiments is intended to encompass all design modifications and equivalents falling within the technical scope of the present invention. For example, in all of the coil components 100A to 100L according to the above descriptions, both the second direction, which is the direction in which outer end parts 13 and 23 face, and the fourth direction, which is one of the directions in which the two-dimensional arrays of coil array sheets 500A to 500L are aligned, were the X1-X2 direction, but it is not limited to this. The plurality of coil conductor portions 20 may be aligned in directions orthogonal to each other in an XY plane, and the outer end parts 13 and 23 may face a direction other than the X1-X2 direction and the Y1-Y2 direction of the XY plane, or the outer end parts 13 and 23 may face the X1-X2 direction but the plurality of coil conductor portions 20 may be aligned in a direction different from the X1-X2 direction, resulting in them being aligned in two non-orthogonal directions in the XY plane.

The foregoing outlines the features of several embodiments, enabling those skilled in the art to fully appreciate the aspects of the present disclosure. Those skilled in the art should recognize that the present disclosure provides a foundation for designing or modifying other processes and structures to achieve substantially the same functions and/or substantially the same results as those of the embodiments introduced herein. Furthermore, such equivalent arrangements do not deviate from the spirit and scope of the present disclosure, and various changes, substitutions, and alterations may be made without so departing.

What is claimed is:

1. A coil component, comprising:
a coil portion including a first spiral conductor portion having a spiral shape as viewed in a first direction;
a main body portion covering and contacting the coil portion in a manner that two ends of the coil portion are exposed, and including a magnetic powder;
a discrete conductor portion having a portion embedded in the main body portion and being spaced from the coil portion; and
a pair of external electrodes contacting the two ends of the coil portion, which are exposed from the main body portion, and electrically connected through the coil portion,
wherein among surfaces extending along the first direction, when a surface shared with the first spiral conductor portion is defined as a first surface,
the discrete conductor portion includes a first discrete conductor portion having a first exposed surface exposed from the main body portion in an in-plane direction of the first surface, and
the first discrete conductor portion contacts one of the pair of external electrodes at the first exposed surface.

2. The coil component according to claim 1, further comprising:
a second spiral conductor portion having a spiral shape and arranged alongside the first spiral conductor portion in the first direction; and
a via conductor portion contacting one end of the first spiral conductor portion and one end of the second spiral conductor portion to electrically connect the first spiral conductor portion and the second spiral conductor portion in the first direction,
wherein among the surfaces extending along the first direction, when a surface shared with the second spiral conductor portion is defined as a second surface,
the discrete conductor portion has a second exposed surface exposed from the main body portion in an in-plane direction of the second surface, and includes a second discrete conductor portion that is electrically independent from the first discrete conductor portion in the main body portion, and
the second discrete conductor portion contacts the other of the pair of external electrodes at the second exposed surface.

3. A coil component, comprising:
a coil portion including a first spiral conductor portion having a spiral shape as viewed in a first direction;
a main body portion covering and contacting the coil portion in a manner that two ends of the coil portion are exposed, and including a magnetic powder; and
a pair of external electrodes contacting the two ends of the coil portion exposed from the main body portion and electrically connected through the coil portion,
wherein the coil portion further comprises a first lead-out portion contacting the other end of the first spiral conductor portion and one of the pair of external electrodes, and
wherein among surfaces extending along the first direction, when a surface shared with the first spiral conductor portion is defined as a first surface,
the first lead-out portion has a first lead-out exposed surface exposed from the main body portion, and
the first lead-out exposed surface extends along a line of intersection between a surface of the main body portion and the first surface.

4. The coil component according to claim 3, further comprising:
a second spiral conductor portion having a spiral shape and arranged alongside the first spiral conductor portion in the first direction; and
a via conductor portion contacting one end of the first spiral conductor portion and one end of the second spiral conductor portion to electrically connect the first spiral conductor portion and the second spiral conductor portion in the first direction,
wherein among the surfaces extending along the first direction, when a surface shared with the second spiral conductor portion is defined as a second surface,
the second lead-out portion has a second lead-out exposed surface exposed from the main body portion, and
the second lead-out exposed surface extends along a line of intersection between a surface of the main body portion and the second surface.

5. A coil component, comprising:
a coil portion including a first spiral conductor portion having a spiral shape as viewed in a first direction;
a main body portion covering and contacting the coil portion in a manner that two ends of the coil portion are exposed, and including a magnetic powder; and
a pair of external electrodes contacting the two ends of the coil portion exposed from the main body portion and electrically connected through the coil portion
wherein at least one of the two ends of the coil portion extends on a surface of the main body portion along a line where the surface of the main body portion intersects a first surface extending along the first direction and shared with the first spiral conductor portion.

6. The coil component according to claim 1, wherein:
an envelope shape of the main body portion is a substantially rectangular parallelepiped, and
the first discrete conductor portion is exposed from the main body portion on an edge of the rectangular parallelepiped.

7. The coil component according to claim 1, wherein:
the main body portion has an envelope shape, which includes a pair of intersecting surfaces aligned in the first direction and an outer surface located between the pair of intersecting surfaces, and
a point farthest from the first spiral conductor portion on a line of intersection between the outer surface and the first surface is included in the first exposed surface.

8. The coil component according to claim 6, wherein a contact surface between the first discrete conductor portion and the main body portion has a curvature toward a corner of the rectangular parallelepiped within the first surface.

9. The coil component according to claim 1, wherein the two ends of the coil portion becomes wider in the first surface while getting further away from the first spiral conductor portion.

10. The coil component according to claim 1, wherein the discrete conductor portion is formed of Cu or a Cu alloy.

11. A coil array sheet, comprising:
a plurality of coil portions, each including a first spiral conductor portion having a spiral shape as viewed in a first direction; and
a connecting part that connects the plurality of coil portions to each other,
wherein an outer end of a spiral in the first spiral conductor portion faces one side of a second direction that is one in-plane direction having the first direction as a normal line,
the plurality of coil portions include a first array in which a plurality of the first spiral conductor portions are arranged in a third direction that is another in-plane direction having the first direction as a normal line and intersects the second direction,
the connecting part includes a first connecting part including a plurality of first coupling parts, each being connected to one of the outer ends of the first spiral conductor portions, and a first bridge portion that connects the plurality of first coupling parts and extends as a whole in the third direction, and
the first bridge portion includes a first bending suppression portion that includes a portion extending in a direction intersecting the third direction, and suppresses bending of the first bridge portion in a direction other than the third direction.

12. The coil array sheet according to claim 11, wherein the coil portion further comprises:
a second spiral conductor portion having a spiral shape and arranged alongside the first spiral conductor portion in the first direction; and
a via conductor portion contacting one end of the first spiral conductor portion and one end of the second spiral conductor portion to electrically connect the first spiral conductor portion and the second spiral conductor portion in the first direction,
wherein an outer end of a spiral in the second spiral conductor portion faces the other side of the second direction,
the plurality of coil portions include a second array in which a plurality of the second spiral conductor portions are arranged in the third direction and which is arranged alongside the first array in the first direction,
the connecting part includes a second connecting part including a plurality of second coupling parts, each being connected to one of the outer ends of the second spiral conductor portions, and a second bridge portion that connects the plurality of second coupling parts and extends as a whole in the third direction, and
the second bridge portion includes a second bending suppression portion that includes a portion extending in a direction intersecting the third direction and suppresses bending of the second bridge portion in a direction other than the third direction.

13. The coil array sheet according to claim 11, wherein the first bending suppression portion includes a crank portion including a portion extending in a direction intersecting the third direction.

14. The coil array sheet according to claim 13, wherein the direction intersecting the third direction includes a component of the first direction.

15. The coil array sheet according to claim 13, wherein the direction intersecting the third direction includes a component of the second direction.

16. The coil array sheet according to claim 11, wherein the first bending suppression portion includes a frame-shaped portion having a polygonal envelope shape when viewed in the first direction or the second direction.

17. The coil array sheet according to claim 11, wherein:
the first array is a two-dimensional array in which the plurality of one of the first spiral conductor portion are also arranged in a fourth direction that is another in-plane direction having the first direction as a normal line and intersects the third direction,
the connecting part includes a plurality of the first bridge portions and a first auxiliary bridge portion connecting two of the first bridge portions adjacent to each other in the fourth direction, and
the first auxiliary bridge portion includes a first auxiliary bending suppression portion that includes a portion extending in a direction intersecting an extending direction thereof and suppresses bending of the first auxiliary bridge portion.

18. The coil array sheet according to claim 12, wherein:
the first array is a two-dimensional array in which the first spiral conductor portions are further arranged in a fourth direction that is another in-plane direction having the first direction as a normal line,
the second array is a two-dimensional array in which the second spiral conductor portions are further arranged in the fourth direction,
the connecting part includes a plurality of the first bridge portions and a plurality of the second bridge portions, and includes a first auxiliary bridge portion connecting two of the first bridge portions adjacent to each other in the fourth direction and a second auxiliary bridge portion connecting two of the second bridge portions adjacent to each other in the fourth direction,
the first auxiliary bridge portion includes a first auxiliary bending suppression portion that includes a portion extending in a direction intersecting an extending direction thereof and suppresses bending of the first auxiliary bridge portion, and
the second auxiliary bridge portion includes a second auxiliary bending suppression portion that includes a portion extending in a direction intersecting an extending direction thereof and suppresses bending of the second auxiliary bridge portion.

19. The coil array sheet according to claim 17, wherein:
the first connecting part forms a first closed path enclosing at least one of the first spiral conductor portions when viewed in the first direction, and
the first closed path includes at least one of the first bending Suppression portion and the first auxiliary bending suppression portion.

20. The coil array sheet according to claim 18, wherein:
the first connecting part forms a first closed path enclosing at least one of the first spiral conductor portions when viewed in the first direction,
the first closed path includes at least one of the first bending suppression portion and the first auxiliary bending suppression portion,
the second connecting part forms a second closed path enclosing at least one of the second spiral conductor portions when viewed in the first direction, and
the second closed path includes at least one of the second bending suppression portion and the second auxiliary bending suppression portion.

21. The coil array sheet according to claim 12, wherein the first bridge portion and the second bridge portion have an overlapping portion when viewed in the first direction.

22. The coil array sheet according to claim 18, wherein the first auxiliary bridge portion and the second auxiliary bridge portion have an overlapping portion when viewed in the first direction.

23. A method for manufacturing a coil component, comprising:
a conductor forming step of forming a conductor on an insulating sheet;
a removal step of removing at least a part of an exposed portion of the insulating sheet that is not covered by the conductor to produce a coil array sheet including a plurality of coil portions, each including a spiral conductor portion having a spiral shape as viewed in a first direction and having a portion made of the conductor, and a connecting part connecting the plurality of coil portions;
a shape-forming step of covering the coil array sheet with a material containing a magnetic powder and conducting shaping to form a magnetic sheet having the first direction as a thickness direction; and
a cutting step of cutting the magnetic sheet at least in the first direction to form a plurality of coil chips, each including one of the coil portions and the material containing the magnetic powder located around the coil portion,
wherein the connecting part includes a plurality of closed paths, each of the plurality of closed paths encloses one or more of the spiral conductor portions when viewed in the first direction, and
the plurality of closed paths include a bending suppression portion that includes a portion extending in a direction intersecting an extending direction of the closed path and suppresses bending of the coil array sheet.
